(19) United States
(12) Patent Application Publication
(10) Pub. No.: US 2015/0229514 A1
(43) Pub. Date: Aug. 13, 2015

(54) TERMINAL MANAGEMENT SYSTEM, TERMINAL MANAGEMENT METHOD, MEDIUM STORING TERMINAL MANAGEMENT PROGRAM, AND COMMUNICATION SYSTEM

(71) Applicants: Taro OKUYAMA, Tokyo (JP); Akihiro Mihara, Tokyo (JP)

(72) Inventors: Taro OKUYAMA, Tokyo (JP); Akihiro Mihara, Tokyo (JP)

(21) Appl. No.: 14/607,617

(22) Filed: Jan. 28, 2015

(30) Foreign Application Priority Data
Feb. 10, 2014 (JP) 2014-022939

(51) Int. Cl. H04L 12/24; H04L 29/08

(52) U.S. Cl. CPC H04L 41/082; H04L 67/1097

(57) ABSTRACT

In a terminal management system, first terminal information indicating a communication terminal is stored in association with terminal identification information for identifying the communication terminal for each one of a plurality of communication terminals. The terminal management system further stores, for each one of one or more of the plurality of communication terminals that is registered as a counterpart terminal for a request sender terminal capable of starting communication, second terminal information indicating the communication terminal in association with the terminal identification information for identifying the communication terminal. The terminal management system updates, in response to updating of the first terminal information of a first communication terminal of the plurality of communication terminals, the second terminal information of the first communication terminal to match with the updated first terminal information.

### CROSS-REFERENCE TO RELATED APPLICATIONS

This patent application is based on and claims priority pursuant to 35 U.S.C. §119(a) to Japanese Patent Application No. 2014-022939, filed on Feb. 10, 2014, in the Japan Patent Office, the entire disclosure of which is hereby incorporated by reference herein.

### BACKGROUND

1. Technical Field

The present invention relates to managing information regarding a communication terminal.

2. Description of the Related Art

Communication systems that perform a videoconference, communication, or the like via a communication network such as the Internet or a dedicated line have become popular in recent years due to a demand for reducing business trip costs and time, and the like. When communication is started between a plurality of communication terminals in such a communication system, image data and sound data are transmitted/received.

In communication systems where the tElephone NUmber Mapping (ENUM) technology is applied, each of information communication apparatuses manages, in its address book, its communication partners' telephone numbers and counterpart terminal information such as uniform resource identifier (URI) information corresponding thereto, and a domain name system (DNS) server manages the same types of information. For example, according to JP-4407400-B, each of information communication apparatus sends an inquiry to a DNS server by using a telephone number registered in its address book as a key, and, when counterpart terminal information obtained from the DNS server does not match counterpart terminal information registered in the address book, automatically updates the counterpart terminal information registered in the address book in accordance with the obtained counterpart terminal information. In this manner, the information communication apparatus, which is capable of communicating both via a telephone line and via a network, can automatically update counterpart terminal information registered in its address book on the basis of counterpart terminal information managed by the DNS server.

### SUMMARY

Example embodiments of the present invention include a terminal management system, which includes: a first memory area that stores, for each one of a plurality of communication terminals, first terminal information indicating the communication terminal in association with terminal identification information for identifying the communication terminal; a second memory area that stores, for each one of one or more of the plurality of communication terminals that is registered as a counterpart terminal for a request sender terminal capable of starting communication, second terminal information indicating the communication terminal in association with the terminal identification information for identifying the communication terminal, the second terminal information of the communication terminal being set by the request sender terminal; and processing circuitry that updates, in response to updating of the first terminal information of a first communication terminal of the plurality of communication terminals, the second terminal information of the first communication terminal to match with the updated first terminal information.

Other embodiments of the present invention include a communication system including the terminal management system, a method of managing terminal information performed by the terminal management system, and a terminal information management program stored in a recording medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram of a communication system according to an embodiment of the present invention;

FIG. 2 is an illustration of transmission/reception of image data, sound data, and various types of management information in the communication system of FIG. 1;

FIG. 3 is an external view of a communication terminal in the communication system of FIG. 1;

FIG. 4 is a hardware configuration diagram of the communication terminal of FIG. 3;

FIG. 5 is a hardware configuration diagram of a communication management system, a relay device, a program providing system, a maintenance system, or a communication terminal management system in the communication system of FIG. 1;

FIG. 6 is a functional block diagram of a communication terminal and the communication management system in the communication system of FIG. 1;

FIG. 7 is an illustration of a terminal authentication management table;

FIG. 8 is an illustration of a terminal management table;

FIG. 9 is an illustration of a candidate list management table;

FIG. 10 is an illustration of transmission/reception of various types of management information in the communication system of FIG. 1;

FIGS. 11A and 11B (FIG. 11) are a sequence diagram illustrating operation of preparing for starting communication between communication terminals;

FIG. 12 is an illustration of a candidate list;

FIG. 13 is a sequence diagram illustrating operation of changing common basic information, performed by the communication system of FIG. 1, according to an embodiment of the present invention;

FIG. 14 is an illustration of a common basic information editing screen;

FIG. 15 is an illustration of a candidate list;

FIG. 16 is an illustration of an example of an alert dialog;

FIG. 17 is a sequence diagram illustrating operation of changing common basic information;

FIG. 18 is an illustration of another example of the alert dialog;

FIG. 19 is an illustration of a candidate list management table;

FIG. 20 is a sequence diagram illustrating operation of performing the counterpart terminal name auto-update setting from a user personal computer (PC) terminal;

FIG. 21 is an illustration of a candidate list;

FIG. 22 is a sequence diagram illustrating operation of changing the common basic information; and

FIG. 23 is a flowchart illustrating operation of determining whether to permit updating of a counterpart terminal name.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Hereinafter, embodiments of the present invention will be described using the drawings.

### First Embodiment

First, a first embodiment of the present invention will be described.

### <Overall Configuration of Communication System>

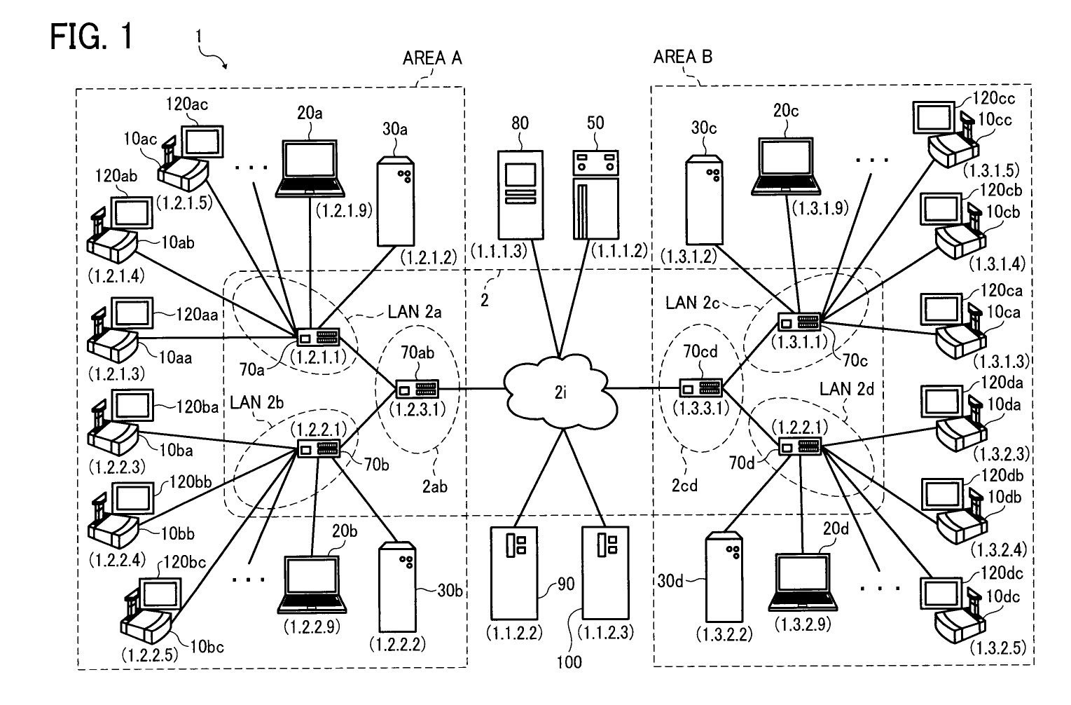

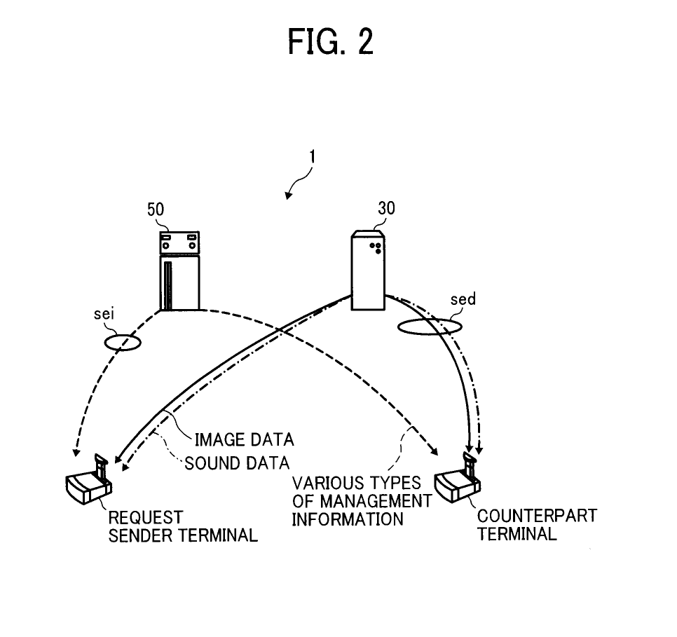

FIG. 1 is a schematic diagram of a communication system according to the first embodiment of the present invention. FIG. 2 is an illustration of transmission/reception of image data, sound data, and various types of information in the communication system of FIG. 1.

The communication system 1 includes a communication system that intercommunicates information, information that reflects feelings, or the like between a plurality of communication terminals 10 via a communication management system 50. Examples of this communication system include a videoconference system and a teleconference system.

In the embodiment, the communication system, the communication management system, and the communication terminal will be described while assuming a videoconference system serving as an example of the communication system, a videoconference management system serving as the communication management system, and a videoconference terminal serving as an example of the communication terminal. That is, the communication terminal and the communication management system according to the embodiment of the present invention are applied not only to a videoconference system, but also to another communication system.

Also in the embodiment, the case in which users in the communication system 1 include four offices, namely, a Tokyo office (user a), an Osaka office (user b), a New York office (user c), and a Washington D.C. office (user d), will be described.

First, the communication system 1 illustrated in FIG. 1 includes the plurality of communication terminals (10aa, 10ab, . . . ), displays (120aa, 120ab, . . . ) for the individual communication terminals (10aa, 10ab, . . . ), a plurality of user PC terminals (20a, 20b, 20c, and 20d), a plurality of relay devices (30a, 30b, 30c, and 30d), the communication management system 50, a communication terminal management system 80, a program providing system 90, and a maintenance system 100.

The plurality of communication terminals 10 perform communication by transmitting and receiving image data and sound data serving as examples of content data.

Hereinafter, the “communication terminal” is simply represented as the “terminal”. In addition, an arbitrary one or ones of the plurality of terminals (10aa, 10ab, . . . ) is/are represented as a “terminal(s) 10”. An arbitrary one or ones of the plurality of displays (120aa, 120ab, . . . ) is/are represented as a “display(s) 120”. An arbitrary one or ones of the plurality of relay devices (30a, 30b, 30c, and 30d) is/are represented as a “relay device(s) 30”. Further, a terminal serving as a request sender that gives a request to start a videoconference is represented as a “request sender terminal”, and a terminal serving as a counterpart terminal that is a request destination (relay destination) is represented as a “counterpart terminal”. In the following description, the user PC terminals (20a, 20b, 20c, and 20d) are respectively represented as “PCs (20a, 20b, 20c, and 20d)”, and further, an arbitrary one or ones of the PCs is/are represented as a “PC(s) 20”.

In addition, as illustrated in FIG. 2, a management information session sei for transmitting and receiving various types of management information is established via the communication management system 50 between a request sender terminal and a counterpart terminal in the communication system 1. Sessions for transmitting and receiving each of image data and sound data via a corresponding one of the relay devices 30 are also established between the request sender terminal and the counterpart terminal. Here, these sessions are collectively indicated as a content data session sed.

A plurality of routers (70a, 70b, 70c, 70d, 70ab, and 70cd) each select an optimal path for image data and sound data. Hereinafter, an arbitrary one or ones of the routers (70a, 70b, 70c, 70d, 70ab, and 70cd) is/are represented as a “router(s) 70”.

The program providing system 90 includes a hard disk (HD) 204 described later. The HD 204 stores a terminal program for causing a terminal 10 to realize various functions (or for causing a terminal 10 to function as various elements), and the terminal program can be transmitted to the terminal 10. In addition, the HD 204 of the program providing system 90 stores a relay device program for causing a relay device 30 to realize various functions (or for causing a relay device 30 to function as various elements), and the relay device program can be transmitted to the relay device 30. Further, the HD 204 of the program providing system 90 stores a communication management program for causing the communication management system 50 to realize various functions (or for causing the communication management system 50 to function as various elements), and the communication management program can be transmitted to the communication management system 50.

The maintenance system 100 is implemented by one or more computers for performing maintenance, management, or conservation of at least one of the terminals 10, the PCs 20, the relay devices 30, the communication management system 50, and the program providing system 90. For example, in the case where the maintenance system 100 is located in one country, and the terminals 10, the PCs 20, the relay devices 30, the communication management system 50, or the program providing system 90 is/are located outside that country, the maintenance system 100 remotely performs, via a communication network 2, maintenance, management, or conservation of at least one of the terminals 10, the PCs 20, the relay devices 30, the communication management system 50, and the program providing system 90. In addition, the maintenance system 100 performs maintenance such as management of the model number, serial number, sales contact, maintenance checkup, or a past history of failures of at least one of the terminals 10, the PCs 20, the relay devices 30, the communication management system 50, and the program providing system 90 without having the communication network 2 therebetween.

The terminals (10aa, 10ab, 10ac, . . . ), the PC 20a, the relay device 30a, and the router 70a are connected to be communicable with each other by a local area network (LAN) 2a. The terminals (10ba, 10bb, 10bc, . . . ), the PC 20b, the relay device 30b, and the router 70b are connected to be communicable with each other by a LAN 2b. In addition, the LAN 2a and the LAN 2b are connected to be communicable with each other by a dedicated line 2ab including the router 70ab and are configured in a certain area A. For example, the area A is Japan, the LAN 2a is configured in the office in Tokyo, and the LAN 2b is configured in the office in Osaka.

The terminals (10ca, 10cb, 10cc, . . . ), the PC 20c, the relay device 30c, and the router 70c are connected to be communicable with each other by a LAN 2c. The terminals (10da, 10db, 10dc, . . . ), the PC 20d, the relay device 30d, and the router 70d are connected to be communicable with each other by a LAN 2d. In addition, the LAN 2c and the LAN 2d are connected to be communicable with each other by a dedicated line 2cd including the router 70cd and are configured in a certain area B. For example, the area B is the United States, the LAN 2c is configured in the office in New York, and the LAN 2d is configured in the office in Washington D.C. The area A and the area B are connected to be communicable with each other from the routers (70ab and 70cd), respectively, via the Internet 2i.

In addition, the communication management system 50, the communication terminal management system 80, and the program providing system 90 are connected to be communicable with the terminals 10, the PCs 20, and the relay devices 30 via the Internet 2i. The communication management system 50, the communication terminal management system 80, and the program providing system 90 may be located in the area A or the area B, or may be located in other areas.

In the embodiment, the communication network 2 of the embodiment includes the LAN 2a, the LAN 2b, the dedicated line 2ab, the Internet 2i, the dedicated line 2cd, the LAN 2c, and the LAN 2d. The communication network 2 may include not only a wired portion, but also a portion where communication is performed wirelessly, such as Wireless Fidelity (WiFi) or Bluetooth (registered trademark).

In addition in FIG. 1, four digits indicated below each of the terminals 10, each of the relay devices 30, the communication management system 50, each of the routers 70, and the program providing system 90 indicates an IP address in an abbreviated form in the general Internet Protocol version 4 (IPv4). For example, the IP address of the terminal 10aa is “1.2.1.3”. Although IPv6 may be used instead of IPv4, IPv4 is used in order to make the description simple.

Note that the terminals 10 may be used not only for communication between different offices or for communication between different rooms in the same office, but also for communication within the same room or for outdoor-indoor communication or outdoor-outdoor communication. In the case where the terminals 10 are used outside, wireless communication using a mobile phone communication network or the like is performed.

### <Hardware Configuration of Communication System>

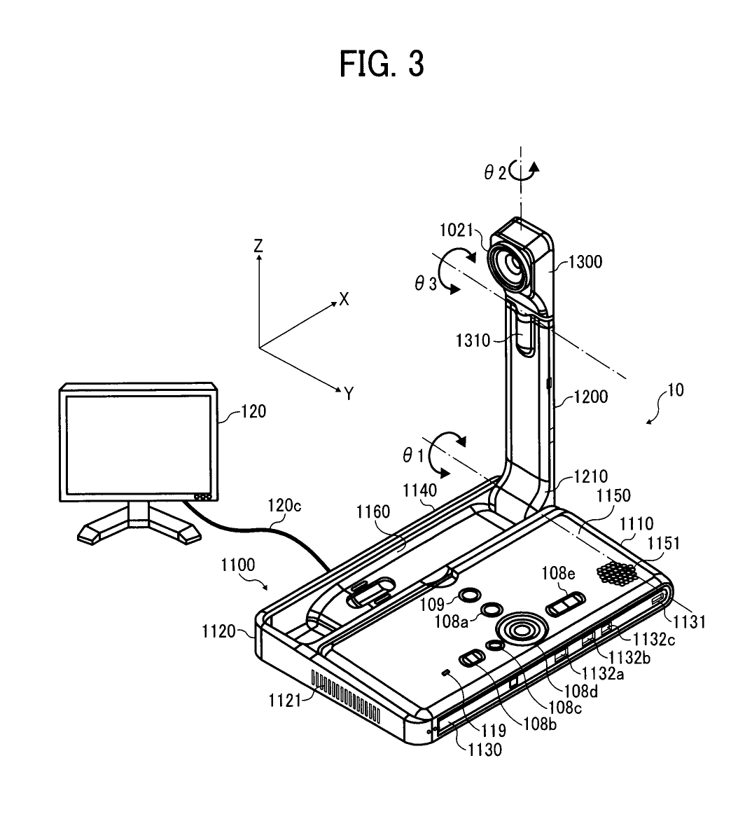

Next, the hardware configuration of the embodiment will be described. FIG. 3 is an external view of a terminal 10 according to the embodiment. The description will be given assuming that the longitudinal direction of the terminal 10 is the X-axis direction, a direction orthogonal to the X-axis direction on one plane is the Y-axis direction, and a direction orthogonal to the X-axis direction and the Y-axis direction (vertical direction) is the Z-axis direction.

As illustrated in FIG. 3, the terminal 10 includes a casing 1100, an arm 1200, and a camera housing 1300. Among these portions, a front wall 1110 of the casing 1100 has an inlet face including a plurality of inlet holes, and a back wall 1120 of the casing 1100 has an exhaust face 1121 on which a plurality of exhaust holes are formed. Accordingly, by driving of a cooling fan included in the casing 1100, air behind the terminal 10 can be taken in via the inlet face and exhausted to the rear of the terminal 10 via the exhaust face 1121. A right-side wall 1130 of the casing 1100 has a sound pickup hole 1131 formed thereon, and a built-in microphone 114, described later, is capable of picking up sound and noise.

An operation panel 1150 is formed toward the right-side wall 1130 of the casing 1100. The operation panel 1150 has a plurality of operation keys (108a to 108e) described later, a power switch 109 described later, and an alarm lamp 119 described later, which are formed thereon. The operation panel 1150 also has a sound output face 1151 formed thereon, which is formed of a plurality of sound output holes for allowing output sound from a built-in speaker 115 described later to pass through. In addition, an accommodation portion 1160 serving as a recess for accommodating the arm 1200 and the camera housing 1300 is formed toward a left-side wall 1140 of the casing 1100. A plurality of connection ports (1132a to 1132c) for electrically connecting cables to an external device connection interface (I/F) 118 described later are provided on the right-side wall 1130 of the casing 1100. In contrast, a connection port (not illustrated) for electrically connecting a cable 120c for a display 120 to the external device connection I/F 118 described later is provided toward the left-side wall 1140 of the casing 1100.

The following description uses the term “operation key(s) 108” for indicating an arbitrary one or ones of the operation keys (108a to 108e), and the term “connection port(s) 1132” for indicating an arbitrary one or ones of the connection ports (1132a to 1132c).

Next, the arm 1200 is attached to the casing 1100 via a torque hinge 1210 and is configured to be rotatable in the vertical direction within a range of a tilt angle θ1 of 135 degrees with respect to the casing 1100. FIG. 3 indicates a state in which the tilt angle θ1 is 90 degrees.

The camera housing 1300 has a built-in camera 112 provided thereon, which will be described later, and the camera 112 can capture an image of a user, a document, a room, or the like. The camera housing 1300 also has a torque hinge 1310 formed thereon. The camera housing 1300 is attached to the arm 1200 via the torque hinge 1310 and is configured to be rotatable in the vertical and horizontal directions within a range of a pan angle θ2 of ±180 degrees and a tilt angle θ3 of ±45 degrees with respect to the state illustrated in FIG. 3 serving as 0 degrees.

Note that the external view illustrated in FIG. 3 is only exemplary and the appearance is not restricted thereto. The terminal 10 may be, for example, a general PC, a smart phone, a tablet terminal, an electronic black board, a projector, a car navigation apparatus mounted on a car, an image forming apparatus such as a multifunction peripheral or a printer, a wearable terminal, or the like. The camera 112 and the microphone 114 need not necessarily be built-in devices and may be external devices.

Since the PCs 20, the relay devices 30, the communication management system 50, the communication terminal management system 80, the program providing system 90, and the maintenance system 100 each have the same appearance as that of a general server computer, descriptions of the appearances thereof are omitted.

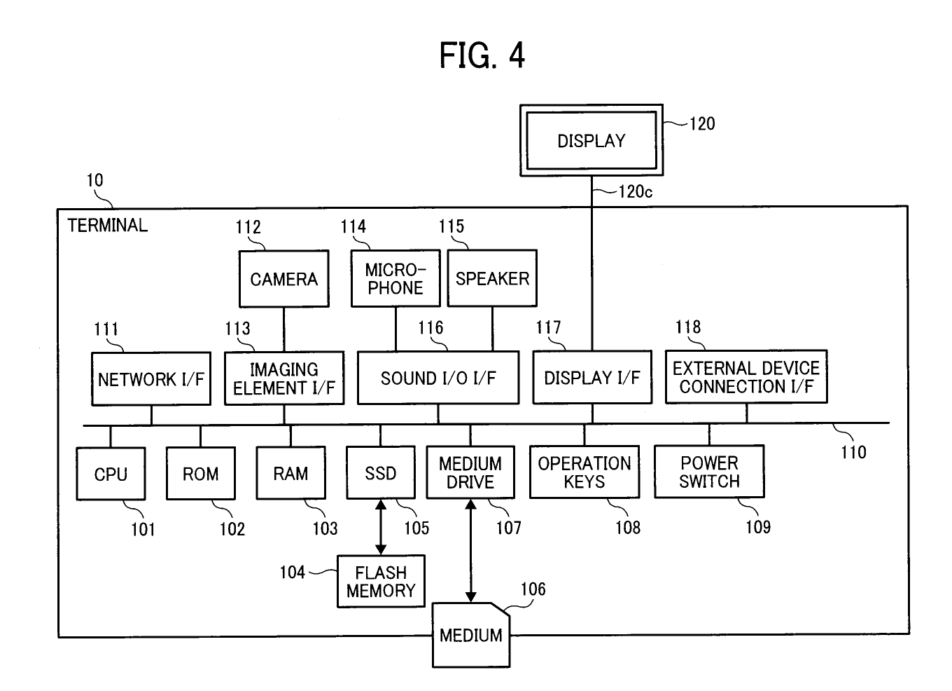

FIG. 4 is a hardware configuration diagram of a terminal 10 according to the embodiment of the present invention. As illustrated in FIG. 4, the terminal 10 includes a central processing unit (CPU) 101 that controls the overall operation of the terminal 10, a read-only memory (ROM) 102 that stores a program used for driving the CPU 101, such as an initial program loader (IPL), a random-access memory (RAM) 103 used as a work area for the CPU 101, a flash memory 104 that stores various types of data, such as the terminal program, image data, and sound data, a solid state drive (SSD) 105 that controls reading/writing of various types of data from/to the flash memory 104 under control of the CPU 101, a medium drive 107 that controls reading/writing (storage) of data from/to a recording medium 106 such as a flash memory, the operation keys 108 operated in the case of, for example, selecting a counterpart terminal of the terminal 10, the power switch 109 for turning on/off the power of the terminal 10, and a network interface (I/F) 111 for performing data communication using the communication network 2.

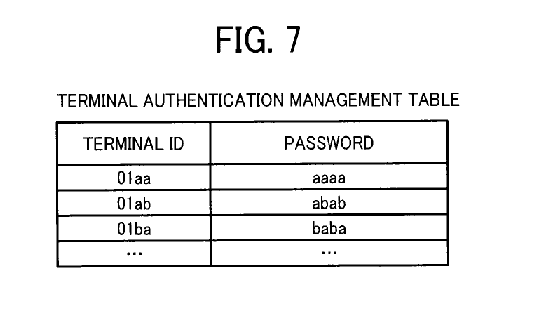

In addition, the terminal 10 includes the built-in camera 112, which captures an image of a subject and obtains image data under control of the CPU 101, an imaging element I/F 113 that controls driving of the camera 112, the built-in microphone 114, which receives a sound input, the built-in speaker 115, which outputs sound, a sound input/output I/F 116 that processes inputting/outputting of a sound signal between the microphone 114 and the speaker 115 under control of the CPU 101, a display I/F 117 that communicates image data to an external display 120 under control of the CPU 101, the external device connection I/F 118 connected to a connection port 1021g illustrated in FIG. 3 in order to connect various external devices, the alarm lamp 119, which indicates an abnormality of various functions of the terminal 10, and a bus line 110 such as an address bus and a data bus for electrically connecting the above-described elements as illustrated in FIG. 7.

Each of the displays 120 displays an image of a subject, an icon for operation, or the like, and is a liquid crystal display (LCD), an organic electroluminescence (EL) display, or the like. In addition, the display 120 is connected to the display I/F 117 by the cable 120c. The cable 120c may be an analog red green blue (RGB) (video graphic array (VGA)) signal cable, a component video cable, a high-definition multimedia interface (HDMI) signal cable, or a digital video interactive (DVI) signal cable.

The camera 112 includes a lens and a solid-state imaging element that converts an image (video) of a subject to electronic data by converting light to electric charge. As the solid-state imaging element, for example, a complementary metal-oxide-semiconductor (CMOS) or a charge-coupled device (CCD) is used.

The external device connection I/F 118 is capable of connecting an external device such as an external camera, an external microphone, or an external speaker by using a Universal Serial Bus (USB) cable or the like. In the case where an external camera is connected, the external camera is driven in preference to the built-in camera 112 under control of the CPU 101. Similarly, in the case where an external microphone is connected or an external speaker is connected, the external microphone or the external speaker is driven in preference to the built-in microphone 114 or the built-in speaker 115 under control of the CPU 101.

Note that the recording medium 106 is configured to be removable from the terminal 10. In addition, a non-volatile memory that reads or writes data under control of the CPU 101 is not limited to the flash memory 104, and an electrically erasable and programmable read-only memory (EEPROM) may be used instead.

Further, the terminal program may be recorded in a file in an installable format or an executable format on a computer-readable recording medium such as the recording medium 106 and circulated. In addition, the terminal program may be stored on the ROM 102, instead of the flash memory 104.

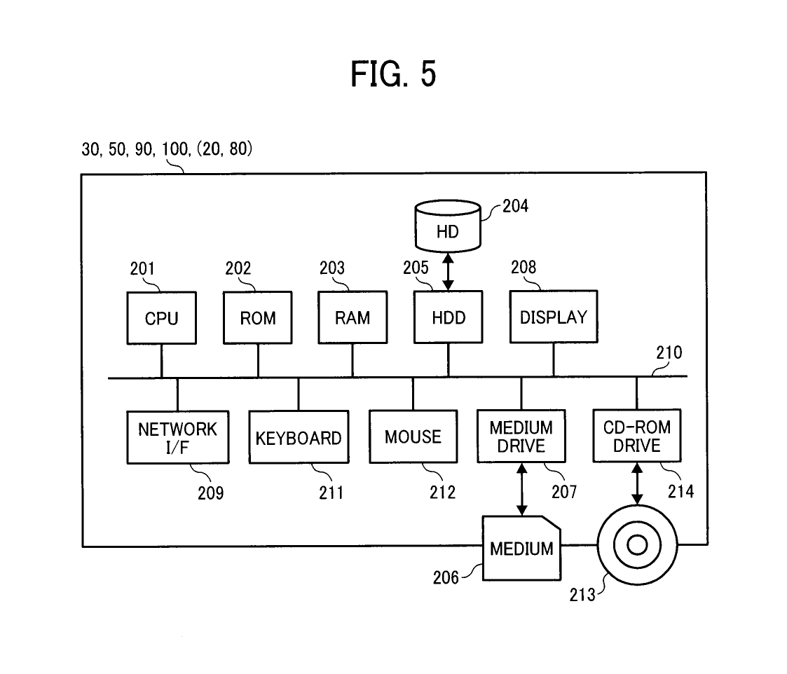

FIG. 5 is a hardware configuration diagram of the communication management system 50 according to the embodiment of the present invention. The communication management system 50 includes a CPU 201 that controls entire operation of the communication management system 50, a ROM 202 that stores a program used for driving the CPU 201, such as an IPL, a RAM 203 used as a work area for the CPU 201, an HD 204 that stores various types of data, such as the communication management program, a hard disk drive (HDD) 205 that controls reading/writing of various types of data from/to the HD 204 under control of the CPU 201, a medium drive 207 that controls reading/writing (storage) of data from/to a recording medium 206 such as a flash memory, a display 208 that displays various types of information such as a cursor, a menu, a window, characters, or an image, a network I/F 209 for communicating data using the communication network 2, a keyboard 211 including a plurality of keys for entering characters, numerals, and various instructions, a mouse 212 that selects and executes various instructions, selects a processing target, and moves the cursor, a compact disc read-only memory (CD-ROM) drive 214 that controls reading/writing of various types of data from/to a CD-ROM 213 serving as an example of a removable recording medium, and a bus line 210 such as an address bus and a data bus for electrically connecting the above-described elements as illustrated in FIG. 5.

Note that the communication management program may be recorded in a file in an installable format or an executable format on a computer-readable recording medium such as the recording medium 206 or the CD-ROM 213 and circulated. In addition, the communication management program may be stored on the ROM 202, instead of the HD 204.

In addition, since the relay devices 30 have a hardware configuration that is the same as or similar to that of the above-described communication management system 50, a description thereof is omitted. Note that the HD 204 stores a relay device program for controlling the relay devices 30. Also in this case, the relay device program may be recorded in a file in an installable format or an executable format on a computer-readable recording medium such as the recording medium 206 or the CD-ROM 213 and circulated. In addition, the relay device program may be stored on the ROM 202, instead of the HD 204.

In addition, since the program providing system 90 and the maintenance system 100 each have a hardware configuration that is the same as or similar to that of the above-described communication management system 50, descriptions thereof are omitted. Note that the HD 204 stores a program providing program for controlling the program providing system 90. Also in this case, the program providing program may be recorded in a file in an installable format or an executable format on a computer-readable recording medium such as the recording medium 206 or the CD-ROM 213 and circulated. In addition, the program providing program may be stored on the ROM 202, instead of the HD 204.

Note that each of the above-described programs may be recorded on a computer-readable recording medium such as a compact disc recordable (CD-R), a digital versatile disk (DVD), or a Blu-ray disk, which serve as other examples of the above-described removable recording medium, and may be provided.

Further, since the PCs 20 and the communication terminal management system 80 each have a hardware configuration that is the same as or similar to that of the above-described communication management system 50, descriptions thereof are omitted. Note that a web application program and data provided to each terminal 10 are recorded on the HD 204 of the communication terminal management system 80.

### <Functional Configuration of Communication System>

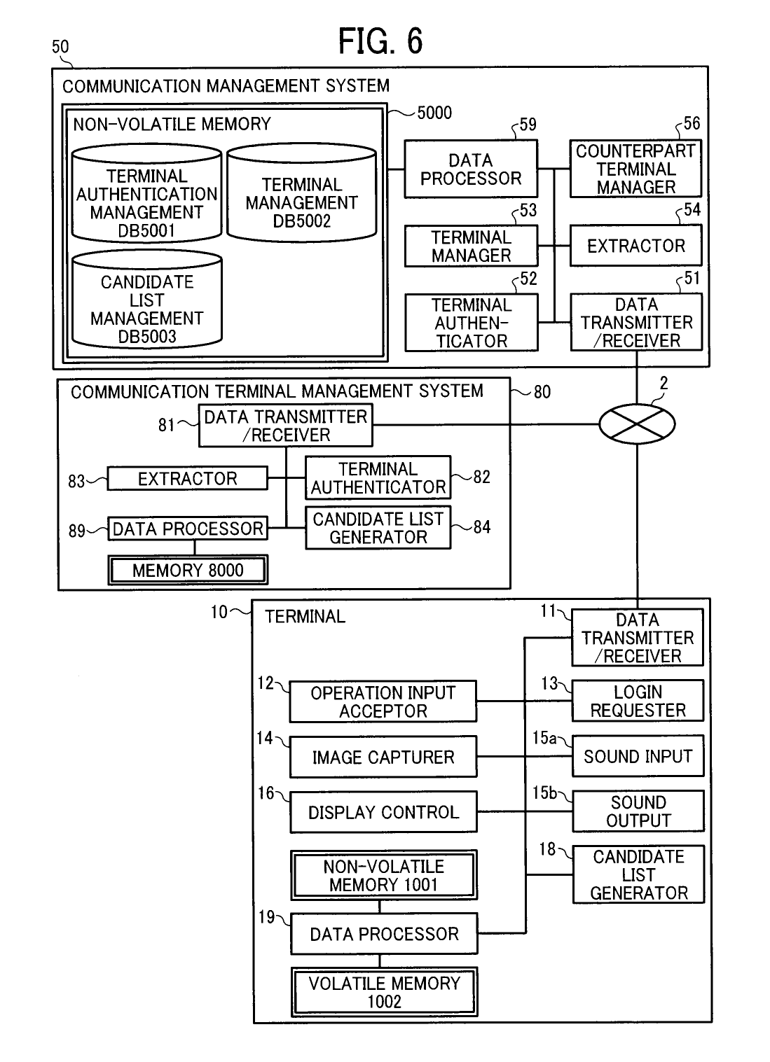

Next, the functional configuration of the embodiment will be described. FIG. 6 is a functional block diagram of a terminal 10, the communication terminal management system 80, and the communication management system 50 included in the communication system 1 of the embodiment. In FIG. 6, the terminal 10, the communication terminal management system 80, and the communication management system 50 are connected to be capable of communicating data via the communication network 2. In addition, since the program providing system 90 illustrated in FIG. 1 is not directly related to videoconference communication, the program providing system 90 is omitted in FIG. 6. Also, since the PCs 20 illustrated in FIG. 1 are general PCs, they are omitted in FIG. 6.

### <Functional Configuration of Terminal>

The terminal 10 includes a data transmitter/receiver 11, an operation input acceptor 12, a login requester 13, an image capturer 14, a sound input 15a, a sound output 15b, a display control 16, a candidate list generator 18, and a data processor 19. These elements are functions that are realized by or caused to function by operating any of the elements illustrated in FIG. 4 in response to a command from the CPU 101 in accordance with a terminal program expanded from the flash memory 104 to the RAM 103.

In addition, the terminal 10 includes a volatile memory 1002 that may be implemented by the RAM 103 illustrated in FIG. 4, and a non-volatile memory 1001 that may be implemented by the flash memory 104 illustrated in FIG. 4.

Next, using FIGS. 4 and 6, functional configuration of the terminal 10 will be described. Note that, in the following description of functional configuration of the terminal 10, among elements illustrated in FIG. 4, relationships with main elements for realizing the functional configuration of the terminal 10 will also be described.

The data transmitter/receiver 11 of the terminal 10 illustrated in FIG. 6 is realized by a command from the CPU 101 illustrated in FIG. 4 and by the network I/F 111 illustrated in FIG. 4, and performs transmission/reception of various types of data (or information) to/from another terminal, apparatus, or system via the communication network 2. Before starting communication with a desired counterpart terminal, the data transmitter/receiver 11 starts receiving, from the communication management system 50, operation state information indicating the operation state of each terminal 10 serving as a candidate counterpart terminal. The operation state information not only indicates the operation state of each terminal 10 (whether the terminal 10 is online or offline), but also indicates a detailed state such as whether the terminal 10 whose state is online is now communicating or the user of the terminal 10 is not at the terminal 10. In addition, the operation state information not only indicates the operation state of each terminal 10, but also indicates various states, such as the state that the cable 120c is disconnected from the terminal 10, the state that the terminal 10 can output sound but not images, or the state that the terminal 10 is muted.

The operation input acceptor 12 is implemented by a command from the CPU 101 illustrated in FIG. 4 and by the operation keys 108 and the power switch 109 illustrated in FIG. 4, and accepts various inputs from the user. For example, when the user turns on the power switch 109 illustrated in FIG. 4, the operation input acceptor 12 illustrated in FIG. 6 accepts the power on operation and turns on the power.

The login requester 13 is implemented by a command from the CPU 101 illustrated in FIG. 4, and, in response to acceptance of the above-described power on operation, automatically transmits, from the data transmitter/receiver 11 to the communication management system 50 via the communication network 2, login request information indicating a login request, and the current IP address of the request sender terminal. In addition, when the user turns the power switch 109 from on to off, the data transmitter/receiver 11 transmits to the communication management system 50 state information indicating that the power is to be turned off, and then the operation input acceptor 12 completely turns off the power. Accordingly, the communication management system 50 can detect that the power of the terminal 10 is turned from on to off.

The image capturer 14 is implemented by a command from the CPU 101 illustrated in FIG. 4 and by the camera 112 and the imaging element I/F 113 illustrated in FIG. 4. The image capturer 14 captures an image of a subject and outputs image data obtained by capturing the image.

The sound input 15a is implemented by a command from the CPU 101 illustrated in FIG. 4 and by the sound input/output I/F 116 illustrated in FIG. 4. After the voice of the user is converted to a sound signal by the microphone 114, the sound input 15a receives sound data according to this sound signal. The sound output 15b is realized by a command from the CPU 101 illustrated in FIG. 4 and by the sound input/output I/F 116 illustrated in FIG. 4, and outputs the sound signal according to the sound data to the speaker 115, and the speaker 115 outputs sound.

The display control 16 is realized by a command from the CPU 101 illustrated in FIG. 4 and by the display I/F 117 illustrated in FIG. 4, and performs control for transmitting image data to the external display 120.

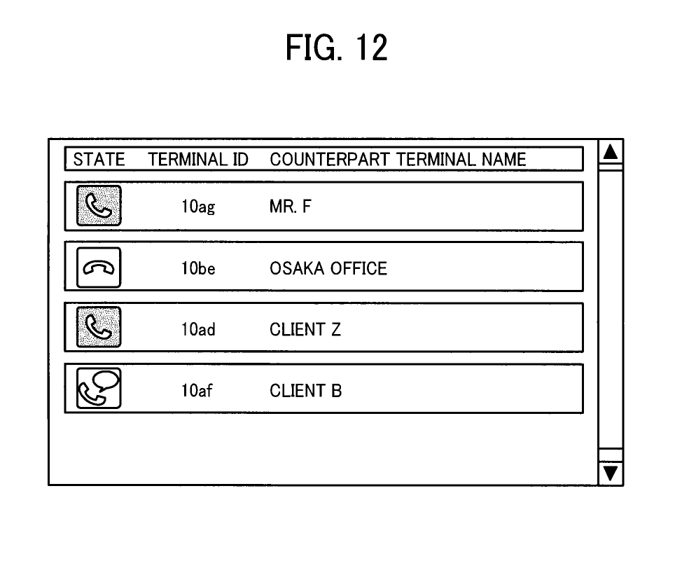

The candidate list generator 18 generates and updates a candidate list in which the state of a candidate counterpart terminal such as that illustrated in FIG. 12 is indicated by an icon, on the basis of later-described candidate list information and the state information of each terminal 10 serving as a candidate counterpart terminal, which are received from the communication management system 50.

In addition, the data processor 19 is executed by a command from the CPU 101 illustrated in FIG. 4 and by the SSD 105 illustrated in FIG. 4, and performs processing to store various types of data in the non-volatile memory 1001 or to read various types of data stored in the non-volatile memory 1001. The non-volatile memory 1001 stores a terminal identification (ID) serving as an example of identification information for identifying the terminal 10, a password, and the like. Further, the data processor 19 also performs processing to store various types of data in the volatile memory 1002 or to read various types of data stored in the volatile memory 1002. Every time image data and sound data are received in performing communication with a counterpart terminal, the volatile memory 1002 overwrites and stores the image data and sound data. Among these items of data, on the basis of image data before being overwritten, an image is displayed on the display 120, and, on the basis of sound data before being overwritten, sound is output from the speaker 115.

Note that the terminal ID in the embodiment, which is one example of identification information for uniquely identifying the terminal 10 or relay device 30, may be expressed using a language, a character(s), a symbol(s), or various marks. Alternatively, the terminal ID may be expressed using a combination of at least two of the above-mentioned language, character(s), symbol(s), and various marks.

### <Functional Configuration of Management System>

The communication management system 50 includes a data transmitter/receiver 51, a terminal authenticator 52, a terminal manager 53, an extractor 54, a counterpart terminal manager 56, and a data processor 59. These elements are functions that are realized by or elements that are caused to function by operating any of the elements illustrated in FIG. 5 in response to a command from the CPU 201 in accordance with a management system program expanded from the HD 204 to the RAM 203. In addition, the communication management system 50 includes a non-volatile memory 5000 in which various types of data (or information) is kept stored even when the power of the communication management system 50 is turned off, and the non-volatile memory 5000 is configured by the HD 204 illustrated in FIG. 5. In addition, the non-volatile memory 5000 stores candidate list frame data illustrated in FIG. 12 (which is data of a candidate list frame portion illustrated in FIG. 12, and which includes no icon indicating a specific operation state, no terminal ID, or no terminal name).

### (Terminal Authentication Management Table)

FIG. 7 is an illustration of a terminal authentication management table. The non-volatile memory 5000 stores a terminal authentication management DB 5001, such as the terminal authentication management table of FIG. 7. The terminal authentication management table stores a password in association with each of terminal IDs of all terminals 10 managed by the communication management system 50. For example, the terminal authentication management table illustrated in FIG. 7 indicates that the terminal ID of the terminal 10aa is “01aa”, and the password of the terminal 10aa is “aaaa”. Note that, in the embodiment, the terminal ID may be any information with which a terminal 10 serving as a communication destination can be identified. As long as the terminal 10 can be specified, such information may not be terminal-specific information that is unique to a terminal 10. For example, the terminal ID may be replaced by information for identifying a user who uses a terminal 10, or may be replaced by identification information stored in a recording medium that can be loaded to a terminal 10. Alternatively, the terminal ID may be replaced by a phone number, an IP address, a URI, or the like.

### (Terminal Management Table)

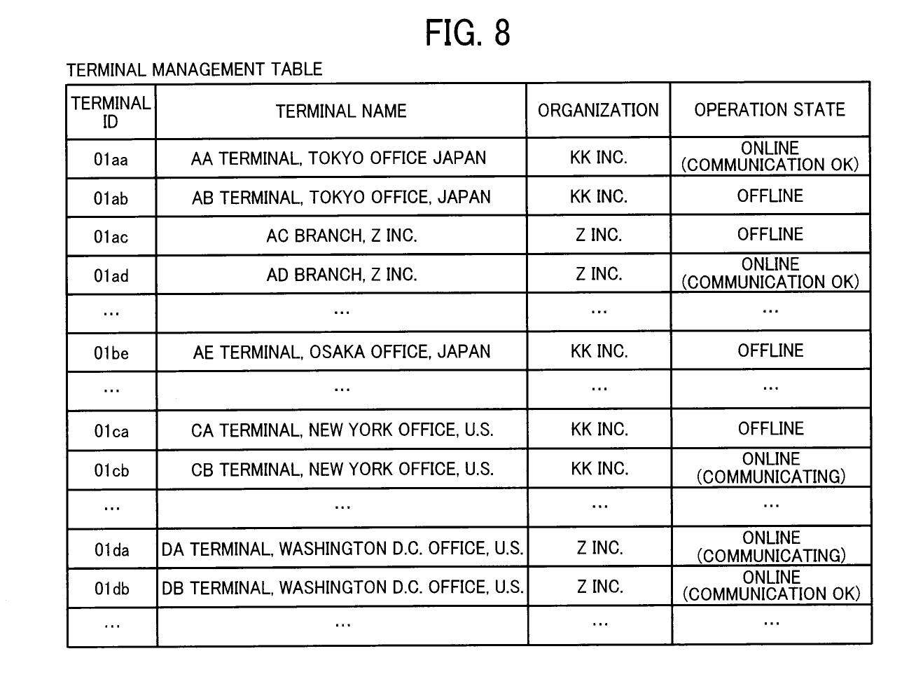

FIG. 8 is an illustration of a terminal management table. The non-volatile memory 5000 stores a terminal management DB 5002, such as a terminal management table of FIG. 8. In the terminal management table, the counterpart terminal name, organization, and operation state of each terminal 10 in the case where the terminal 10 serves as a counterpart terminal are stored in association with the terminal ID of the terminal 10. For example, the terminal management table illustrated in FIG. 8 indicates that the terminal 10aa whose terminal ID is “01aa” has the terminal name “AA terminal, Tokyo office, Japan”, the organization “KK Inc.”, and the operation state “online (communication OK)”. Note that one or a plurality of terminals 10 other than the terminal 10 associated with the terminal name and the organization in the terminal management table can be notified of the terminal name and the organization. The terminal 10 notified of the terminal name and the organization can also use the terminal name and/or the organization that is notified as a counterpart terminal name. Hereinafter, the terminal name and the organization will be referred to as common basic information. Note that the common basic information can be changed on the basis of a request from the terminal 10 associated with the common basic information in the terminal management table.

### (Candidate List Management Table)

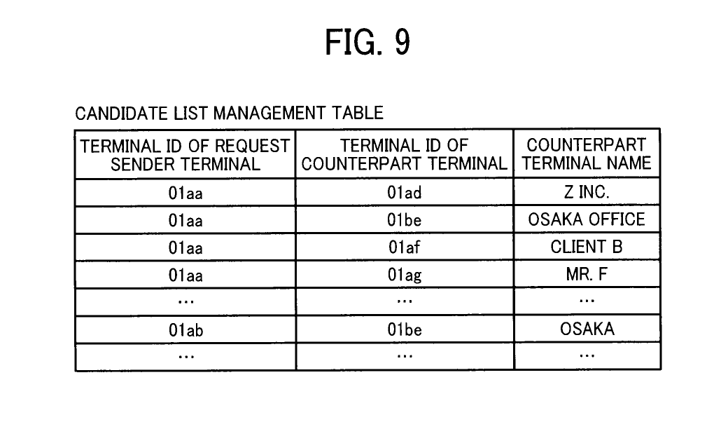

FIG. 9 is an illustration of a candidate list management table. The non-volatile memory 5000 stores a candidate list management DB 5003, such as a candidate list management table of FIG. 9. In the candidate list management table, the terminal IDs and counterpart terminal names of all terminals 10 registered as candidate counterpart terminals are stored in association with the terminal ID of a request sender terminal that gives a request to start communication in a videoconference. For example, the candidate list management table illustrated in FIG. 9 indicates that candidates for a counterpart terminal to which a request sender terminal (terminal 10aa) whose terminal ID is “01aa” can give a request to start communication in a videoconference are the terminal 10ad whose terminal ID is “01ad”, the terminal 10be whose terminal ID is “01be”, and so forth. Note that each request sender terminal can arbitrarily set the counterpart terminal name of each counterpart terminal associated with the terminal ID of this request sender terminal in the candidate list management table. The candidate list management table indicates that the counterpart terminal name of a counterpart terminal (terminal 10be) of a request sender terminal (terminal 10aa) is “Osaka office”, and the counterpart terminal name of a counterpart terminal (terminal 10be) of a request sender terminal (terminal 10ab) is “Osaka”. Candidates for a counterpart terminal in the candidate list management table are updated by registration or deletion in response to a registration or deletion request from an arbitrary request sender terminal to the communication management system 50.

### (Functional Configuration of Management System)

Next, functional configuration of the communication management system 50 will be described in detail. Note that, in the following description of functional configuration of the communication management system 50, among elements illustrated in FIG. 5, relationships with main elements for realizing the functional configuration of the communication management system 50 will also be described.

The data transmitter/receiver 51 is achieved by a command from the CPU 201 illustrated in FIG. 5 and by the network I/F 209 illustrated in FIG. 5, and performs transmission/reception of various types of data (or information) to/from another terminal, apparatus, or system via the communication network 2.

The terminal authenticator 52 is achieved by a command from the CPU 201 illustrated in FIG. 5, and performs terminal authentication by searching the terminal authentication management DB 5001 in the non-volatile memory 5000 by using a terminal ID and a password included in login request information received via the data transmitter/receiver 51 as search keys and determining whether the same pair of a terminal ID and a password is managed in the terminal authentication management DB 5001.

The terminal manager 53 is achieved by a command from the CPU 201 illustrated in FIG. 5. In order to manage the operation state of a request sender terminal that has given a login request, the terminal manager 53 stores the terminal ID and the operation state of this request sender terminal in association with each other in the terminal management DB 5002 (see FIG. 8). In addition, on the basis of operation state information sent from the terminal 10 indicating that power is to be turned off when the user turns the power switch 109 of the terminal 10 from on to off, the terminal manager 53 changes the operation state indicating an online state to an offline state in the terminal management DB 5002 (see FIG. 8). Further, the terminal manager 53 changes the common basic information (terminal name and organization) of the terminal 10 managed in the terminal management table (see FIG. 8), on the basis a request from the terminal 10 to change the common basic information.

The extractor 54, which is achieved by a command from the CPU 201 illustrated in FIG. 5, searches the candidate list management DB 5003 (see FIG. 9) by using the terminal ID of a request sender terminal that has given a login request as a key, and reads the terminal ID of a candidate counterpart terminal that can communicate with the request sender terminal, thereby extracting the terminal ID. In addition, the extractor 54 searches the terminal management DB 5002 (see FIG. 8) by using the terminal ID of a candidate counterpart terminal extracted by the extractor 54 as a search key, and reads the operation state for each terminal ID extracted by the extractor 54. Accordingly, the extractor 54 can obtain the operation state of a candidate counterpart terminal that can communicate with a request sender terminal that has given a login request.

The counterpart terminal manager 56, which is achieved by a command from the CPU 201 illustrated in FIG. 5, updates the candidate list management table (see FIG. 9) by storing or deleting a counterpart terminal name in the candidate list management table.

The data processor 59, which is achieved by a command from the CPU 201 illustrated in FIG. 5 and the HDD 205 illustrated in FIG. 5, performs processing to store various types of data in the non-volatile memory 5000 or read various types of data stored in the non-volatile memory 5000.

### (Functional Configuration of Communication Terminal Management System)

The communication terminal management system 80 includes a data transmitter/receiver 81, a terminal authenticator 82, an extractor 83, a candidate list generator 84, and a data processor 89. These elements are functions that are realized by or elements that are caused to function by operating any of the elements illustrated in FIG. 5 in response to a command from the CPU 201 in accordance with a communication terminal management system program expanded from the HD 204 to the RAM 203.

In addition, the communication terminal management system 80 includes a memory 8000 configured by the RAM 203 or the HD 204 illustrated in FIG. 5.

### (Functional Configuration of Communication Terminal Management System)

Next, functional configuration of the communication terminal management system 80 will be described in detail. Note that, in the following description of functional configuration of the communication terminal management system 80, among elements illustrated in FIG. 5, relationships with main elements for realizing the functional configuration of the communication terminal management system 80 will also be described.

The data transmitter/receiver 81, which is achieved by a command from the CPU 201 illustrated in FIG. 5 and by the network I/F 209 illustrated in FIG. 5, performs transmission/reception of various types of data (or information) to/from another terminal, apparatus, or system via the communication network 2. The data transmitter/receiver 81 also has a web server function and a data processing function, which will be described later.

The terminal authenticator 82, which is achieved by a command from the CPU 201 illustrated in FIG. 5, accesses the communication management system 50 and searches the terminal authentication management DB 5001 (see FIG. 7) configured in the non-volatile memory 5000, thereby determining whether the same pair of a terminal ID and a password as that of the request sender terminal has been managed, and authenticating whether the terminal 10 of the user of the PC 20 is a legitimate terminal in this videoconference system.

The extractor 83, which is achieved by a command from the CPU 201 illustrated in FIG. 5, searches the candidate list management DB 5003 (see FIG. 9) configured in the non-volatile memory 5000 of the communication management system 50 by using the terminal ID of the request sender terminal as a search key, thereby extracting the terminal ID of a corresponding counterpart terminal.

The candidate list generator 84, which is achieved by a command from the CPU 201 illustrated in FIG. 5, generates the HyperText Markup Language (HTML) of a candidate list screen illustrated in FIG. 12.

The data processor 89, which is achieved by a command from the CPU 201 illustrated in FIG. 5 and the HDD 205 illustrated in FIG. 5, performs processing to store various types of data in the memory 8000 or read various types of data stored in the memory 8000.

### <Process or Operation of Embodiment>

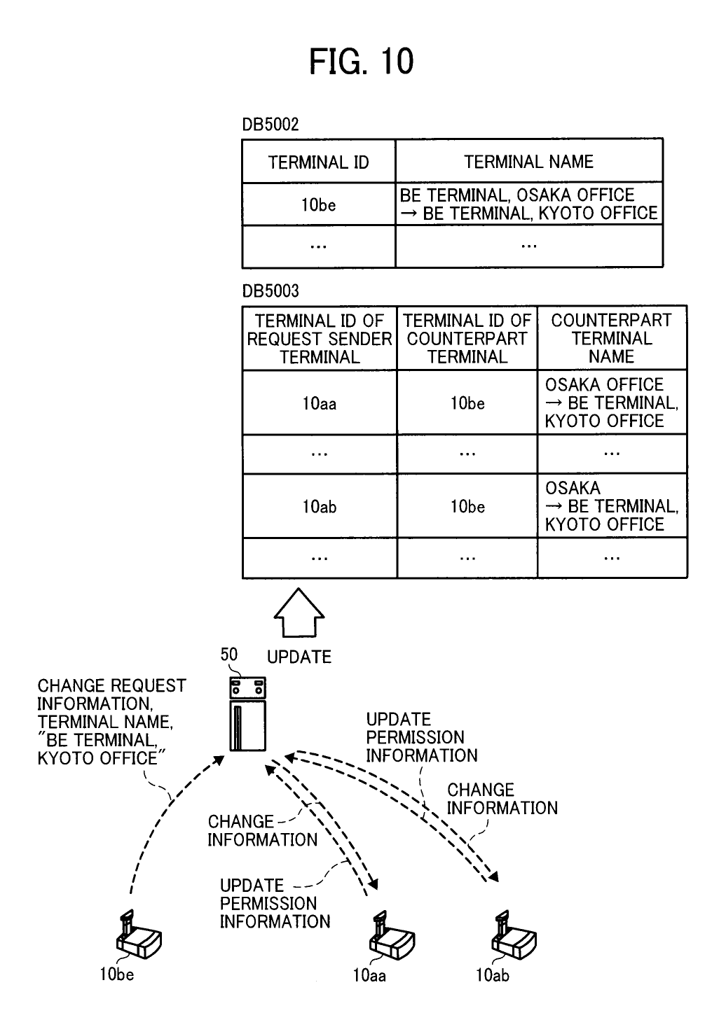

Next, referring to FIG. 10, the outline of an operation or a process of the embodiment will be described. FIG. 10 is an illustration of a transmission/reception state of various types of management information in the communication system.

For example, according to a counterpart terminal information updating method of the related art, in the case where counterpart terminal information managed for each communication terminal does not match counterpart terminal information managed on a DNS server side, the counterpart terminal information managed for each communication terminal is updated on the basis of the counterpart terminal information managed on the DNS server side. However, there may be a case in which, to make selection of a counterpart terminal easier, counterpart terminal information for each communication terminal, such as a counterpart terminal name, is arbitrarily set at each communication terminal. In this case, in the case where counterpart terminal information is updated as before, the arbitrarily-set counterpart terminal information does not match the counterpart terminal information managed on the server side. Therefore, the arbitrarily-set counterpart terminal information is updated, regardless of whether there has been a change in the counterpart terminal information managed on the server side.

In view of the above, the later-described communication management system 50 is configured to update a counterpart terminal name that can be set for each request sender terminal, when the terminal name managed by the communication management system 50 is changed. Accordingly, even in the case where a counterpart terminal name has been arbitrary set for each request sender terminal, the counterpart terminal name is changed at the time when the terminal name managed by the communication management system 50 is changed.

The terminal management DB 5002 of the communication management system 50 stores, for each one of a plurality of terminals 10, the terminal ID for identifying the terminal 10 (an example of terminal identification information) in association with the terminal name of the terminal 10 (an example of first terminal information). The candidate list management DB 5003 of the communication management system 50 stores, for each one of the plurality of terminals 10 serving as a request sender (request sender terminal) for starting communication, the terminal ID of the terminal 10 in association with the terminal ID of a counterpart terminal registered for the request sender terminal 10 and a counterpart terminal name of the counterpart terminal for the terminal 10 (an example of second terminal information) that can be set by the request sender terminal. When the terminal name of the terminal 10be (an example of a first communication terminal) stored in the terminal management DB 5002 is changed, the counterpart terminal manager 56 of the communication management system 50 updates a counterpart terminal name associated with the terminal ID for identifying the terminal 10be in the candidate list management DB 5003, with the terminal name in the terminal management DB 5002. Accordingly, in response to the change in a terminal name managed using the terminal management DB 5002, the counterpart terminal name for each request sender terminal can be updated with the terminal name that has changed, even in the case where a counterpart terminal name has been arbitrarily set for each request sender terminal.

In one example, when the terminal name of the terminal 10be stored in the terminal management DB 5002 is changed, the data transmitter/receiver 51 (an example of a transmitter) of the communication management system 50 transmits change information indicating a change in the terminal name to each request sender terminal that has the terminal 10be registered as a counterpart terminal. Accordingly, each request sender terminal that has the terminal 10be registered as a counterpart terminal can detect the update of the counterpart terminal name. This prevents confusion in selection of a counterpart terminal due to a change in the counterpart terminal name.

In one example, the data transmitter/receiver 51 of the communication management system 50 receives update permission information indicating permission to update the counterpart terminal name from each terminal 10 that receives the change information, thereby accepting update permission. The counterpart terminal manager 56 updates the counterpart terminal name in response to receiving the update permission by the data transmitter/receiver 51. Accordingly, each request sender terminal is able to select whether to update a counterpart terminal name with a terminal name that has changed, thus improving operability for the user.

In one example, the candidate list management DB 5003 of the communication management system 50 further stores information indicating whether counterpart terminal name auto-update is valid (an example of update permission/rejection information indicating update permission/rejection) for each terminal ID of a request sender terminal. In the case where information indicating that the auto-update is valid is stored in association with the terminal ID of a request sender terminal in the candidate list management DB 5003, the counterpart terminal manager 56 updates a counterpart terminal name of a counterpart terminal that has been registered for this request sender terminal. Accordingly, it becomes possible to preliminarily set permission/rejection of the counterpart terminal name auto-update, thereby reducing the burden on the user of each terminal 10.

In one example, the candidate list management DB 5003 of the communication management system 50 stores, for each terminal ID of a counterpart terminal, information indicating whether the counterpart terminal name auto-update is valid. In the case where information indicating that the auto-update is valid is stored in association with the terminal ID of a counterpart terminal in the candidate list management DB 5003, the counterpart terminal manager 56 updates the counterpart terminal name of this counterpart terminal. Accordingly, it becomes possible to preliminarily set permission/rejection of the auto-update according to each counterpart terminal, thus improving operability for the user.

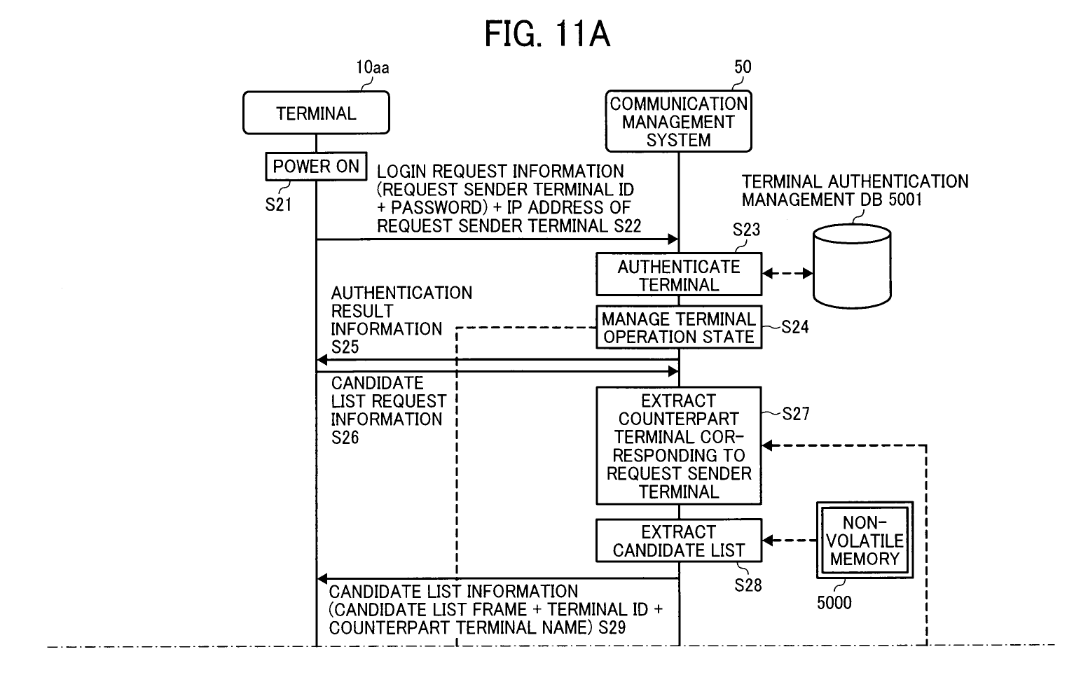

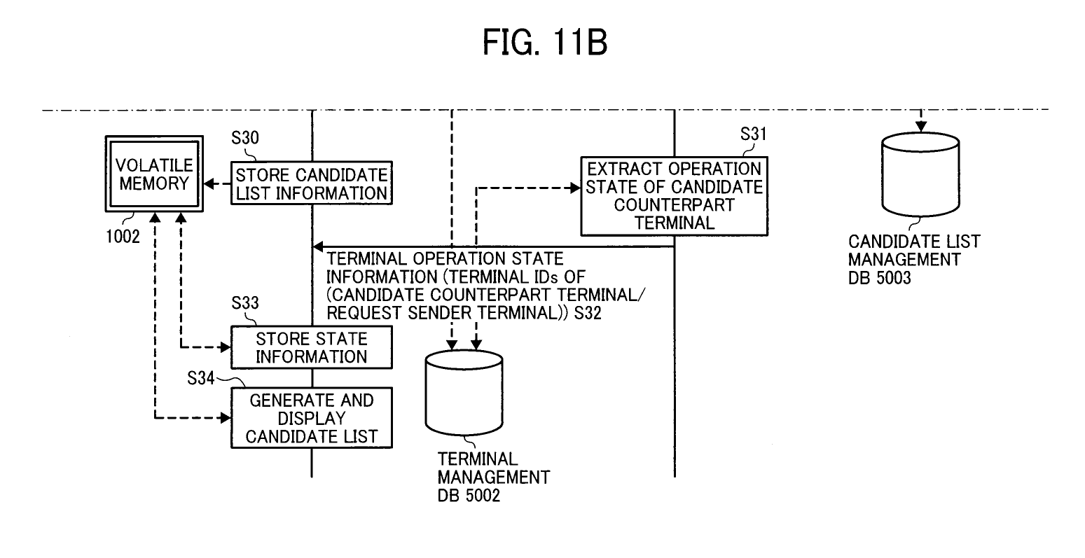

Next, referring to FIGS. 11 to 16, a process of the embodiment will be described. Here, operation of transmitting/receiving each item of management information at a preparation stage before starting communication will be described using FIGS. 11 and 12. FIG. 11 is a sequence diagram illustrating operation of preparing for starting communication between communication terminals. FIG. 12 is an illustration of a candidate list. Note that FIG. 11 illustrates a process of transmitting/receiving various items of management information entirely by a management information session sei.

First, when the user turns on the power switch 109 illustrated in FIG. 4, the operation input acceptor 12 illustrated in FIG. 6 accepts the power on operation and turns on the power (step S21). In response to acceptance of the power on operation, the login requester 13 automatically transmits login request information indicating a login request from the data transmitter/receiver 11 to the communication management system 50 via the communication network 2 (step S22). The login request information includes a terminal ID for identifying the terminal 10aa, which serves as a request sender, and a password. The terminal ID and the password are data that have been read via the data processor 19 from the non-volatile memory 1001 and sent to the data transmitter/receiver 11. In the case of transmitting login request information from the terminal 10aa to the communication management system 50, the communication management system 50, which is a receiving side, can detect the IP address of the terminal 10aa, which is a transmitting side.

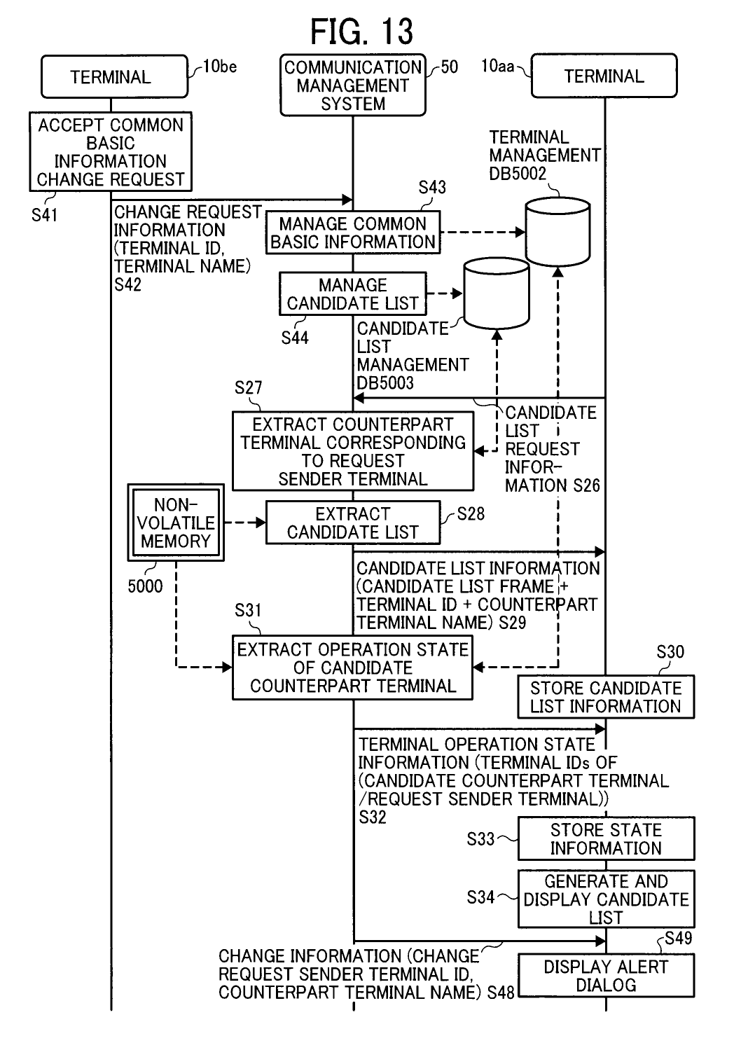

Next, the terminal authenticator 52 of the communication management system 50 performs terminal authentication by searching the terminal authentication management DB 5001 (see FIG. 7) of the non-volatile memory 5000 by using the terminal ID and the password included in the login request information received via the data transmitter/receiver 51 as search keys, and determining whether the same terminal ID and the same password are managed in the terminal authentication management DB 5001 (step S23). In the case where the terminal authenticator 52 determines that the login request is a login request from a terminal 10 that has a legitimate use authority since the same terminal ID and the same password are managed, the terminal manager 53 stores, in the terminal management DB 5002 (see FIG. 8), the operation state and the IP address of the terminal 10aa for a record indicated by the terminal ID of the terminal 10aa (step S24). Accordingly, the operation state “online” and the IP address “1.2.1.3” are stored in association with the terminal ID “01aa” in the terminal management table illustrated in FIG. 13.

The data transmitter/receiver 51 of the communication management system 50 transmits authentication result information indicating an authentication result obtained by the terminal authenticator 52 to the request sender terminal (terminal 10aa) which has given the above-mentioned login request, via the communication network 2 (step S25). In the embodiment, it is assumed that the terminal authenticator 52 determines that the terminal 10aa is a terminal that has a legitimate use authority.

In response to reception, by the request sender terminal (terminal 10aa), of the authentication result information indicating that the request sender terminal is a terminal that has a legitimate use authority, the data transmitter/receiver 11 transmits candidate list request information indicating a request for a candidate list to the communication management system 50 via the communication network 2 (step S26). Accordingly, the data transmitter/receiver 51 of the communication management system 50 receives the candidate list request information.

Next, the extractor 54 searches the candidate list management DB 5003 (see FIG. 9) by using the terminal ID “01aa” of the request sender terminal (terminal 10aa) which has given a login request as a search key, and extracts the terminal ID and the counterpart terminal name of a candidate counterpart terminal that can communicate with the request sender terminal (terminal 10aa) (step S27). Here, the terminal IDs (“01ad”, “01be”, “01af” . . . ) of counterpart terminals (10ad, 10be, 10af, . . . ) corresponding to the terminal ID “01aa” of the request sender terminal (10aa), and terminal names (“Company Z”, “Osaka Office”, “Client B”, . . . ) corresponding thereto are extracted.

Next, the data transmitter/receiver 51 of the communication management system 50 reads data of a candidate list frame from the memory 5000 via the data processor 59 (step S28), and transmits, to the request sender terminal (terminal 10aa), “candidate list information (candidate list frame, terminal IDs, and counterpart terminal names)” including this candidate list frame, and the terminal IDs and counterpart terminal names extracted by the extractor 54 (step S29). Accordingly, in the request sender terminal (terminal 10aa), the data transmitter/receiver 11 receives the candidate list information, and the data processor 19 stores the candidate list information in the volatile memory 1002 (step S30).

In this manner, in the embodiment, instead of managing candidate list information by each terminal 10, the communication management system 50 centrally manages candidate list information of all terminals 10. Therefore, the communication management system 50 centrally manages information to reflect various changes, for example, due to the case where a new terminal 10 is included in the communication system 1, the case where a terminal 10 of a new model is included in place of an already-included terminal 10, or the case where the appearance of the candidate list frame is to be changed. This removes the burden of each terminal 10 changing candidate list information.

In addition, the extractor 54 of the communication management system 50 searches the terminal management DB 5002 (see FIG. 8) by using the terminal IDs (“01ad”, “01be”, “01af”, . . . ) of candidates for a counterpart terminal, which are extracted by the above-mentioned extractor 54, as search keys, and reads a corresponding operation state for each terminal ID extracted by the above-mentioned extractor 54, thereby obtaining the operation state of each of the terminals (10ad, 10be, 10af, . . . ) serving as candidate counterpart terminals (step S31).

Next, the data transmitter/receiver 51 transmits “terminal operation state information” including the terminal ID “01ad” serving as a search key used in step S27 described above and the operation state “online (communication OK)” of a corresponding counterpart terminal (terminal 10ad) to the request sender terminal (terminal 10aa) via the communication network 2 (step S32). In addition, as part of step S32, the data transmitter/receiver 51 also separately transmits the remaining “terminal operation state information”, such as “terminal operation state information” including the terminal ID “01be” and the operation state “offline” of the corresponding counterpart terminal (terminal 10be), to the request sender terminal (terminal 10aa).

Next, the data processor 19 of the request sender terminal (terminal 10aa) sequentially stores the terminal state information, received from the communication management system 50, in the volatile memory 1002 (step S33). Thus, by receiving the above-described state information of each terminal, the request sender terminal (terminal 10aa) can obtain the current operation state of each candidate for a counterpart terminal, such as the terminal 10ad, that can communicate with the request sender terminal (terminal 10aa).

Next, the candidate list generator 18 of the request sender terminal (terminal 10aa) generates a candidate list in which the state of a terminal 10 serving as a candidate counterpart terminal is reflected, on the basis of the candidate list information and the terminal state information stored in the volatile memory 1002, and controls the timing at which the display control 16 displays the candidate list on the display 120 illustrated in FIG. 4 (step S34). Note that, in the candidate list illustrated in FIG. 12, an icon indicating the operation state of each terminal 10 indicates the following from top: “online (communication OK)”, “offline”, “online (communication OK)”, and “online (communicating)”.

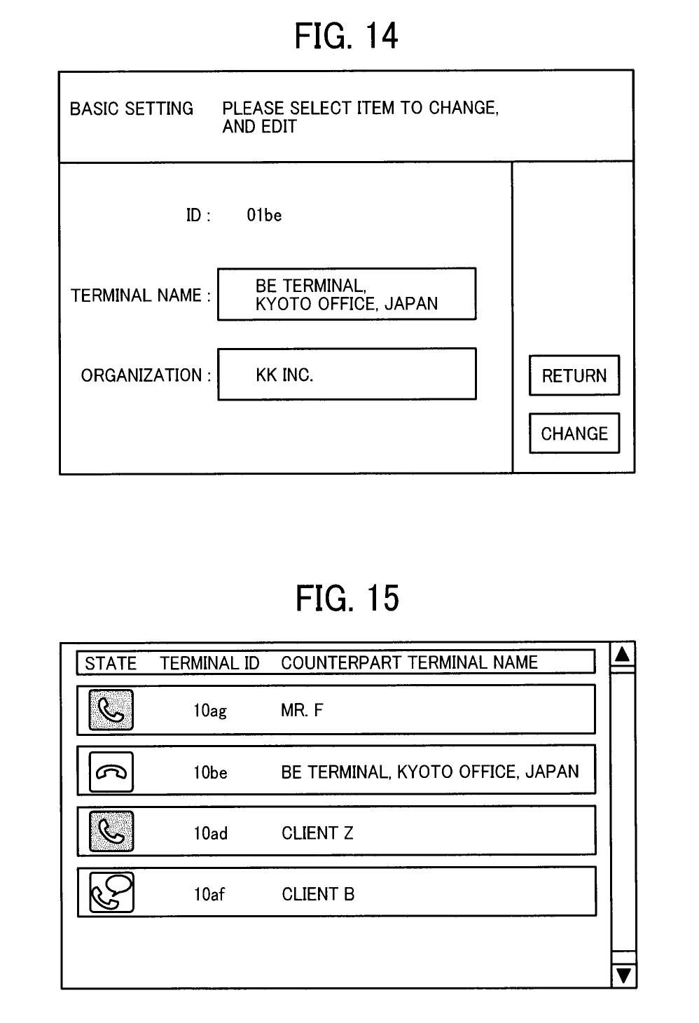

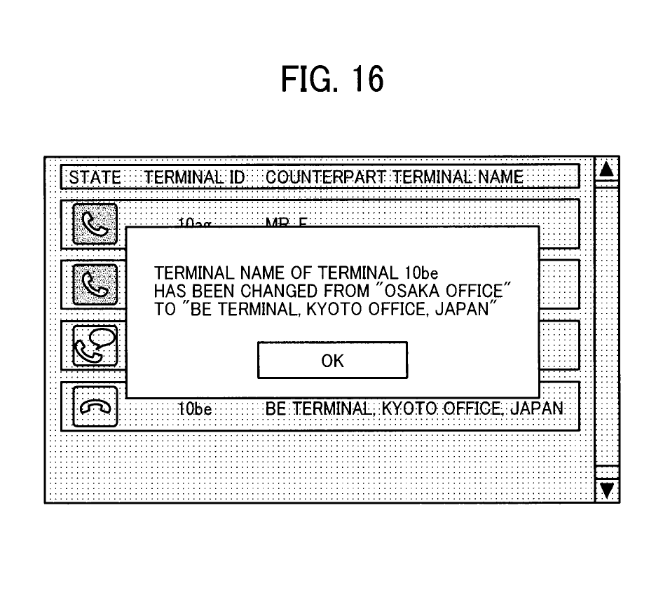

Next, using FIGS. 13 to 16, operation of changing the common basic information of the terminal 10 will be described. The embodiment discusses the case in which the user of the terminal 10be changes its common basic information as a result of office relocation. Note that FIG. 13 is a sequence diagram illustrating operation of changing the common basic information. FIG. 14 is an illustration of a common basic information editing screen. FIG. 15 is an illustration of a candidate list, which is updated to reflect the change in common basic information. FIG. 16 is an illustration of an example of an alert dialog.

In this embodiment, it is assumed that the user at the terminal 10be sends a request for changing the common basic information, before the terminal 10aa sends the candidate list request information at S26 of FIG. 11A. For this reasons, S41 to S44 and S48 and S49 are described below.

As a result of execution of processing that is the same as or similar to steps S21 to S25 described referring to FIG. 11A by the terminal 10be and the communication management system 50, a management information session sei has been established between the terminal 10be and the communication management system 50. When the user of the terminal 10be operates the operation keys 108 in this state, the operation input acceptor 12 performs processing to accept a request for changing the common basic information (step S41). The embodiment discusses an example in which a request for changing the common basic information is accepted by displaying, by the display control 16, the common basic information editing screen (FIG. 14) on the display 120be.

Next, when the user edits an item to change on the common basic information editing screen illustrated in FIG. 14 with the operation keys 108 (here, the user inputs the terminal name “BE terminal, Kyoto office, Japan”) and presses a “change” key, the data transmitter/receiver 11 of the terminal 10be transmits change request information indicating a request for changing the common basic information to the communication management system 50 via the communication network 2 (step S42). This change request information includes the terminal ID “01be” for identifying a terminal serving as a change request sender (terminal 10be), and, as the common basic information, the terminal name after the change “BE terminal, Kyoto office, Japan”. Accordingly, the data transmitter/receiver 51 of the communication management system 50 receives the change request information.

Next, in the communication management system 50, the terminal manager 53 rewrites, in the terminal management table (see FIG. 8), a terminal name managed in association with the terminal ID “01be” of the terminal 10be, which is the change request sender, from “BE terminal, Osaka office, Japan” to “BE terminal, Kyoto office, Japan” (step S43).

Next, the counterpart terminal manager 56 of the communication management system 50 rewrites, in the candidate list management table (see FIG. 9), each counterpart terminal name managed in association with the terminal ID “01be” of the terminal 10be, which is the change request sender, to “BE terminal, Kyoto office, Japan” on the basis of the terminal name after the change (step S44). For example, when “01be” is registered as the terminal ID of a counterpart terminal corresponding to the request sender terminal (terminal 10aa) in the candidate list management table, a counterpart terminal name managed in association with “01be” is rewritten to “BE terminal, Kyoto office, Japan”.

When the terminal 10aa gives a request for a candidate list in this state by performing processing in step S26 described above, the counterpart terminal name after the change is extracted in step S27. Thus, the counterpart terminal name of the terminal 10be in the candidate list is changed to “BE terminal, Kyoto office, Japan” (see FIG. 15).

Note that, at the timing of transmitting the candidate list information from the communication management system 50 or before or after that timing, the data transmitter/receiver 51 can transmit change information including the terminal ID “01be” of the change request sender and the counterpart terminal name before and after the change in step S44 (“Osaka office” and “BE terminal, Kyoto office, Japan”) to the terminal 10aa (step S48).

Upon reception of the change information by the data transmitter/receiver 11 of the terminal 10aa, the display control 16 displays, on the basis of the change information, an alert dialog indicating that the counterpart terminal name of the terminal 10be has been changed, on the display 120aa (step S49, see FIG. 16). Accordingly, the user of the terminal 10aa can see that the counterpart terminal name of the terminal 10be has been updated.

### Second Embodiment

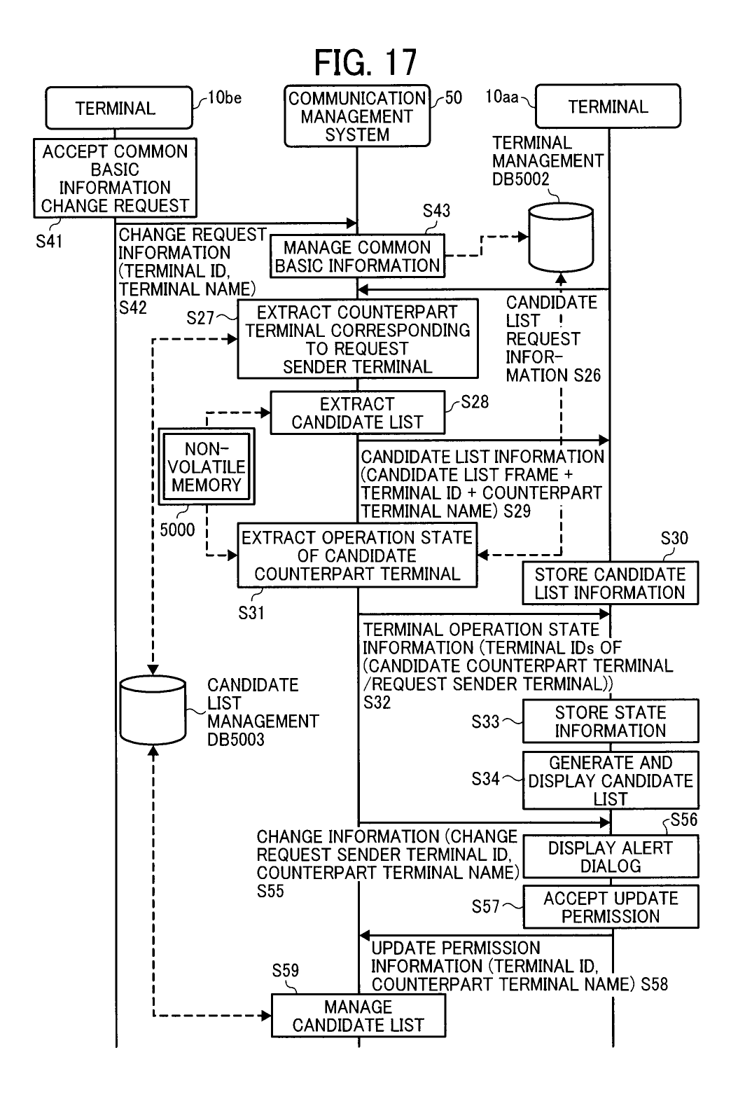

FIG. 17 is a sequence diagram illustrating operation of changing the common basic information according to a second embodiment of the present invention. The points of the second embodiment of the present invention that are different from the first embodiment will be described using FIG. 17. In the second embodiment, after the counterpart terminal manager 56 of the communication management system 50 changes the common basic information (terminal name) of the terminal 10be, which is the change request sender (step S43), S44 of updating the counterpart terminal name for each request sender terminal is not performed. Rather, the counterpart terminal name is updated in response to permission for changing the counterpart terminal name from the request sender terminal (terminal 10aa). That is, even when the counterpart terminal manager 56 changes the common basic information (terminal name) of the terminal 10be, which is the change request sender, until the request sender terminal (terminal 10aa) permits changing of the counterpart terminal name, the counterpart terminal name is not updated (see FIG. 12), and the counterpart terminal name set by the request sender terminal can be continuously used.

In the second embodiment, at the timing of transmitting the candidate list information from the communication management system 50 or before or after that timing, the data transmitter/receiver 51 transmits change information including the terminal ID “01be” of the change request sender and the counterpart terminal name before and after the change (“Osaka office” and “BE terminal, Kyoto office, Japan”) to the terminal 10aa (step S55).

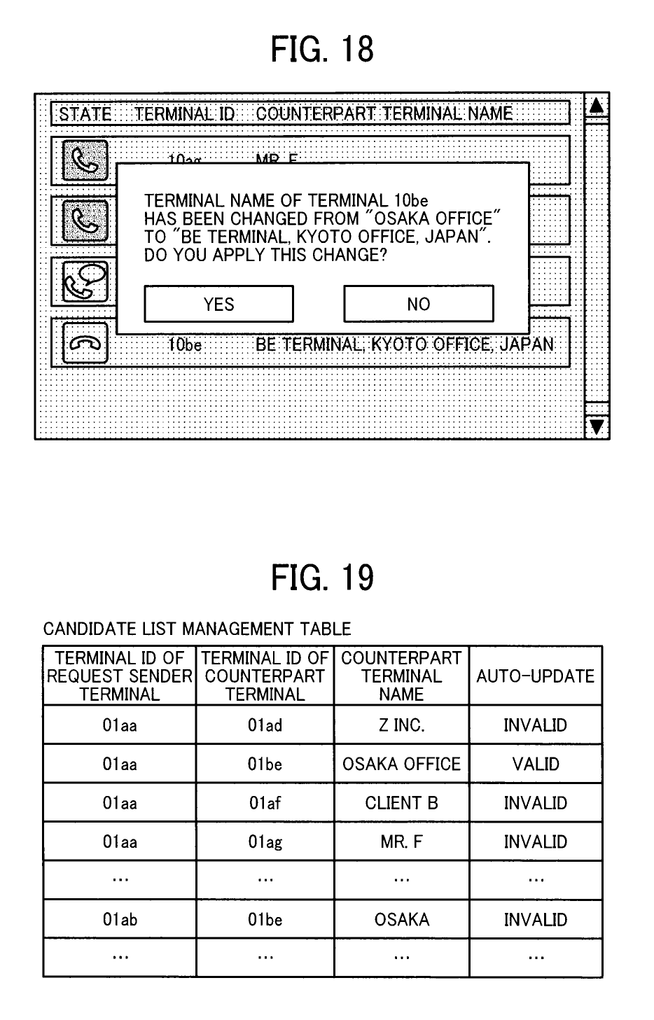

Upon reception of the change information by the data transmitter/receiver 11 of the terminal 10aa, the display control 16 displays, on the basis of the change information, an alert dialog indicating that the counterpart terminal name of the terminal 10be has been changed, on the display 120aa (step S56, see FIG. 18). FIG. 18 is an illustration of an example of an alert dialog. This alert dialog displays a key for selecting whether to apply the terminal name after the change as a counterpart terminal name.

When the user of the terminal 10aa selects an “yes” key on the alert dialog by operating the operation keys 108, the operation input acceptor 12 accepts permission for updating the counterpart terminal name (step S57). Next, the data transmitter/receiver 51 of the terminal 10aa transmits update permission information indicating permission for updating the counterpart terminal name to the communication management system 50 (step S58). This updating permission information includes the terminal ID of the terminal 10aa, which has permitted updating, the terminal ID of the terminal 10be, which is the change request sender, and the counterpart terminal name after the change “BE terminal, Kyoto office, Japan”.

Upon reception of the updating permission information by the data transmitter/receiver 51 of the communication management system 50, the counterpart terminal manager 56 records, as the counterpart terminal name, “BE terminal, Kyoto office, Japan” in association with the terminal ID “01aa” of the terminal 10aa, which is the request sender, and the terminal ID “01be” of the terminal 10be, which is the counterpart terminal, in the candidate list management table (see FIG. 9), thereby updating the candidate list management table. After that, when processing in steps S27 to S29 is executed, the counterpart terminal name after the change is extracted in step S27. Thus, the counterpart terminal name of the terminal 10be in the candidate list is changed to “BE terminal, Kyoto office, Japan” (see FIG. 15).

In contrast, when the user of the terminal 10aa selects a “no” key on the alert dialog by operating the operation keys 108 after the alert dialog is displayed in step S56, the counterpart terminal name in the candidate list management table is not updated, and “BE terminal, Osaka office, Japan” can be continuously used by the terminal 10aa as the counterpart terminal name indicating the terminal 10be.

### Third Embodiment

Referring now to FIGS. 19 to 23, operation of changing the common basic information is explained according to a third embodiment of the present invention. The points of the third embodiment that are different from the first embodiment will be described. In some cases, the user may not be familiar with operating the terminal 10 using the operation keys 108. In view of this, in this embodiment, the user is allowed to use a PC that the user feels more comfortable in operating to perform operation or input.

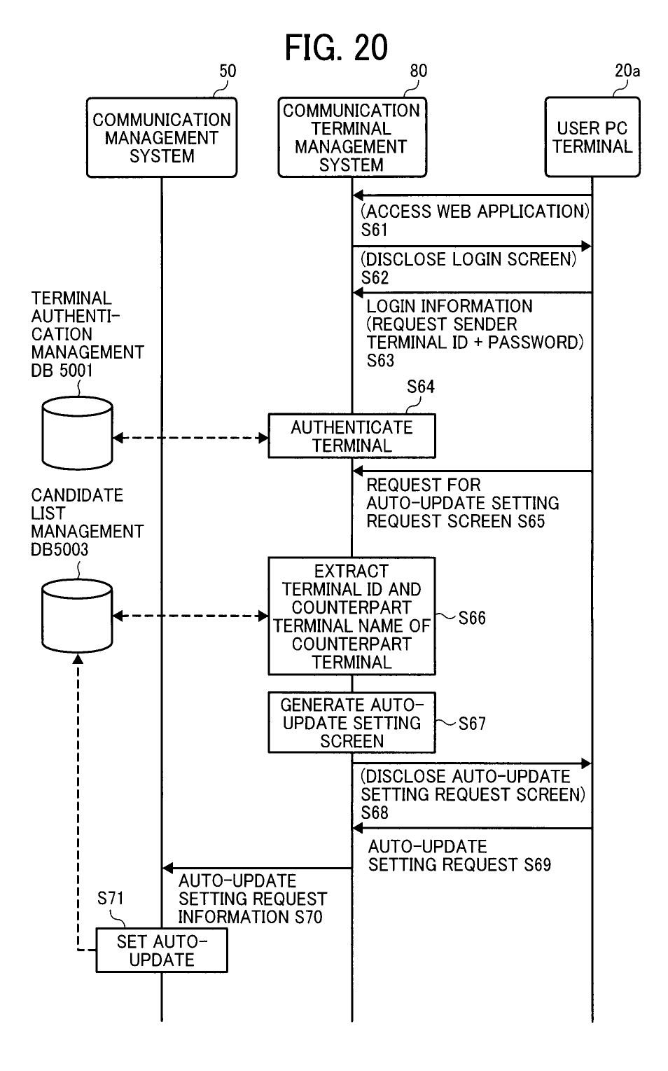

Next, the points of the functional configuration of the embodiment that are different from the first embodiment will be described. FIG. 20 is a sequence diagram illustrating operation of performing auto-update setting of a counterpart terminal name from a PC.

### (Candidate List Management Table)

FIG. 19 is an illustration of a candidate list management table. In the non-volatile memory 5000 of the communication management system 50 according to the third embodiment, the candidate list management DB 5003 stores a candidate list management table such as that illustrated in FIG. 19. In the candidate list management table, the terminal ID of a counterpart terminal registered as a candidate counterpart terminal, a counterpart terminal name when this terminal 10 serves as a counterpart terminal, and information indicating whether the auto-update of this counterpart terminal name is valid or invalid, are all managed in association with the terminal ID of a request sender terminal that gives a request to start communication in a videoconference. For example, the candidate list management table illustrated in FIG. 19 indicates that the auto-update of the counterpart terminal name of a counterpart terminal (terminal 10be) serving as a counterpart terminal of communication from a request sender terminal (terminal 10aa) whose terminal ID is “01aa” is “valid”.

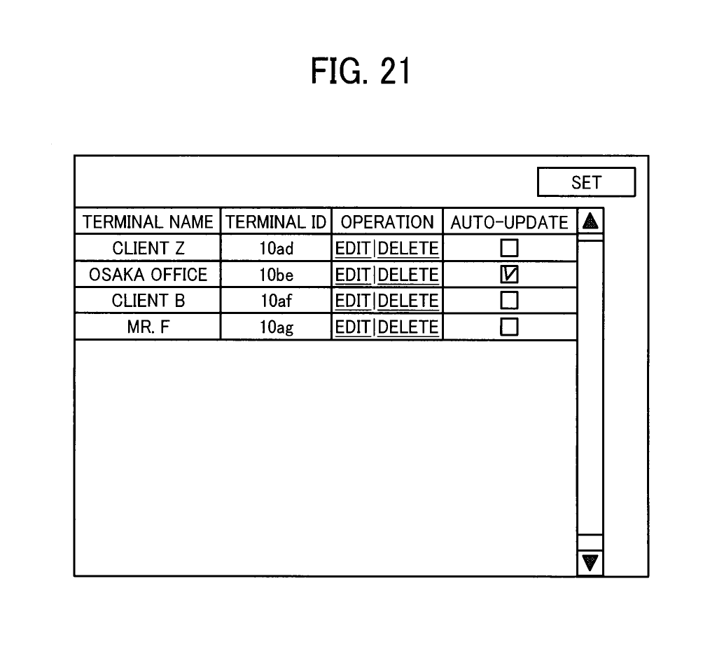

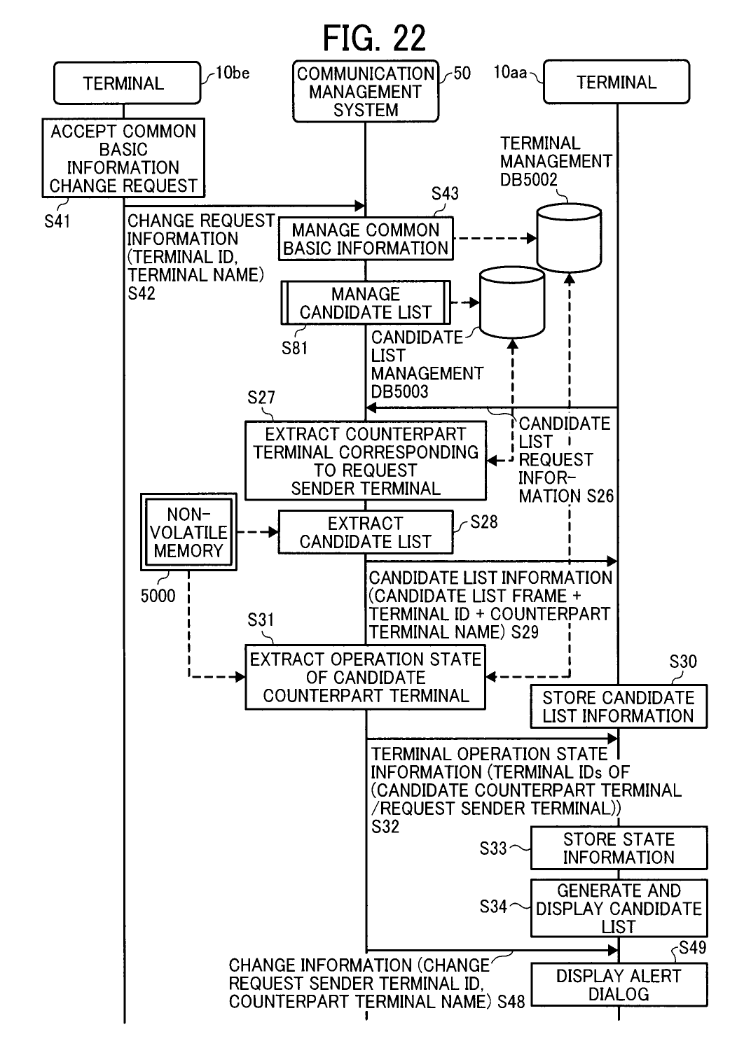

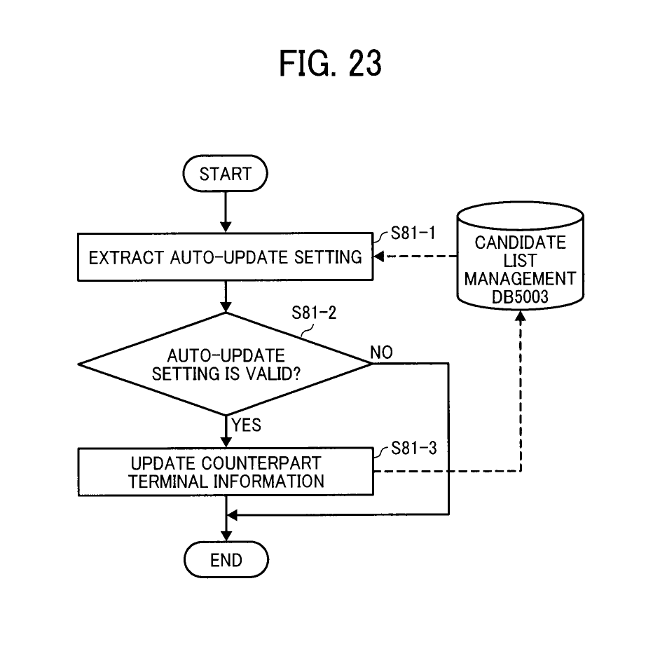

Next, using FIGS. 20 to 23, operation of the third embodiment will be described. FIG. 20 is a sequence diagram illustrating operation of performing the auto-update setting of a counterpart terminal name from a user PC terminal. FIG. 21 is an illustration of a candidate list. FIG. 22 is a sequence diagram illustrating operation of changing the common basic information. FIG. 23 is a flowchart illustrating operation of determining whether to permit updating of a counterpart terminal name.

As illustrated in FIG. 20, when the user a of the PC 20a inputs a uniform resource locator (URL) on a web browser of the PC 20a, the PC 20a accesses a web application provided by the communication terminal management system 80 (step S61). Accordingly, the web server function of the data transmitter/receiver 81 of the communication terminal management system 80 discloses a login screen to the PC 20a, thereby prompting the user a to input the terminal ID and the password of the request sender terminal (terminal 10aa) (step S62). When the user a inputs the terminal ID and the password of the request sender terminal (terminal 10aa) in response to this, the PC 20a transmits login information, which includes the terminal ID and the password of the request sender terminal, to the communication terminal management system 80 (step S63).

Next, the terminal authenticator 82 of the communication terminal management system 80 accesses the communication management system 50 and searches the terminal authentication management DB 5001 (see FIG. 7) configured in the non-volatile memory 5000, thereby determining whether the same pair of a terminal ID and a password as that of the request sender terminal has been managed, and authenticating whether the terminal 10aa of the user a of the PC 20a is a legitimate terminal in this communication system 1 (step S64). After it has been determined by this authentication that the terminal 10aa is a legitimate terminal, the PC 20a gives, on the basis of an operation of the PC 20a by the user a, a request for setting the counterpart terminal name auto-update to the communication terminal management system 80 (step S65). Accordingly, the extractor 83 of the communication terminal management system 80 searches the candidate list management DB 5003 (see FIG. 19) configured in the non-volatile memory 5000 of the communication management system 50 on the basis of the terminal ID “01aa” of the request sender terminal, thereby extracting the terminal ID and the counterpart terminal name of a corresponding counterpart terminal (step S66).

Next, the candidate list generator 84 generates the HTML of a candidate list screen illustrated in FIG. 21, on the basis of the terminal ID and the counterpart terminal name of the counterpart terminal, extracted in step S66 described above (step S67). Note that FIG. 21 is an illustration of the candidate list. The web server function of the data transmitter/receiver 81 discloses the candidate list screen to the PC 20a (step S68). The candidate list screen displays the counterpart terminal name and the terminal ID of each counterpart terminal, an operation region for editing the counterpart terminal name of each counterpart terminal in the candidate list or deleting the counterpart terminal name and the terminal ID of each counterpart terminal from the candidate list, and a check box for specifying whether to validate or invalidate the auto-update of the counterpart terminal name of each counterpart terminal. Although an example in which whether to validate or invalidate the auto-update of the counterpart terminal name of each counterpart terminal is selected will be described in this embodiment, it may be allowed to select whether to validate or invalidate the auto-update of all counterpart terminals.

Next, when the user a presses a “set” key in the candidate list screen by using the PC 20a, the web browser function of the PC 20a accepts an auto-update setting request (step S69). Accordingly, the data processing function of the data transmitter/receiver 81 of the communication terminal management system 80 analyzes the operation performed by the user a, and, in place of the terminal 10aa, transmits counterpart terminal name auto-update setting request information to the communication management system 50 (step S70). This auto-update setting request information includes the terminal ID “01aa” of the terminal 10aa, which is the setting request sender, the terminal ID of each counterpart terminal corresponding to the terminal 10aa, and information indicating whether the automatic setting of each counterpart terminal is valid.

In response to acceptance of the auto-update setting request information by the data transmitter/receiver 51 of the communication management system 50, the counterpart terminal manager 56 records and manages information indicating whether the automatic setting is valid, in association with the terminal ID “01aa” of the request sender terminal and the terminal ID of each counterpart terminal corresponding to the terminal 10aa in the candidate list management table (see FIG. 19) on the basis of the auto-update setting request information (step S71).

Next, the points of a process of changing the common basic information that are different from the first embodiment will be described using FIG. 22. FIG. 22 is a sequence diagram illustrating operation of changing the common basic information. In the third embodiment, the processing in step S44 of the first embodiment (see FIG. 13) is changed to the processing in step S81.

After the communication management system 50 changes the common basic information (terminal name) of the terminal 10be, which is the change request sender (step S43), the counterpart terminal manager 56 updates the counterpart terminal name in accordance with the auto-update setting registered in the candidate list management table (see FIG. 19) (step S81). The processing in step S81 will be described in detail using FIG. 23. FIG. 23 is a flowchart illustrating operation of determining whether to permit updating of a counterpart terminal name.

First, the counterpart terminal manager 56 of the communication management system 50 extracts, from the candidate list management table (see FIG. 19), by using the terminal ID “01be” of the terminal 10be, which is the change request sender, included in the change request information, as a search key, each corresponding auto-update setting (step S81-1). In the case where the extracted auto-update setting is valid (YES in step S81-2), the counterpart terminal name field in the same record as the extracted auto-update record in the candidate list management table is changed to “BE terminal, Kyoto office, Japan” on the basis of the terminal name after the change, thereby updating the candidate list management table (step S81-3). In contrast, in the case where it is determined that the auto-update setting is invalid (NO in step S81-2), the counterpart terminal name in that record is not changed. Note that, in the candidate list management table illustrated in FIG. 19, the counterpart terminal name of a counterpart terminal (terminal 10be) corresponding to the request sender terminal (terminal 10aa) is changed to “BE terminal, Kyoto office, Japan”, but the counterpart terminal name of a counterpart terminal (terminal 10be) corresponding to another request sender terminal (terminal 10ab) is not changed.

As has been described above, according to the embodiments of the present invention, in the case where counterpart terminal information managed by the first counterpart terminal information manager of the counterpart terminal management system is changed, counterpart terminal information that can be set for each request sender is updated on the basis of the counterpart terminal information after the change. Accordingly, even in the case where counterpart terminal information has been arbitrarily set for each request sender, it becomes possible to update, at a timing at which counterpart terminal information managed by the first counterpart terminal information manager is changed, counterpart terminal information that can be set for each request sender.

Note that the relay devices 30, the communication management system 50, the communication terminal management system 80, the program providing system 90, and the maintenance system 100 in the above-described embodiments may be configured by a single computer or a plurality of computers to which divided portions (functions) are arbitrarily allocated. In addition, in the case where the program providing system 90 is configured by a single computer, a program transmitted by the program providing system 90 may be separately transmitted in units of a plurality of modules, or may be transmitted in its entirety. Further, in the case where the program providing system 90 is configured by a plurality of computers, a program may be divided into a plurality of modules, and the modules may be individually transmitted from the respective computers.

In addition, a recording medium storing the terminal program, relay terminal program, communication management program, or communication terminal management system program in the above-described embodiments, the HD 204 storing these programs, and the program providing system 90 including the HD 204 are each used in the case where the terminal program, relay device program, communication management program, or communication terminal management system program is provided as a program product to users within a certain country or outside that country.

In addition, although the case of a videoconference system has been described as an example of the communication system 1 in the above-described embodiments, the embodiments are not limited to this case, and the communication system 1 may be a phone system such as an IP phone system or an Internet phone system. In addition, the communication system 1 may be a car navigation system. In this case, for example, one of two terminals 10 corresponds to a car navigation apparatus mounted on a car, and the other terminal 10 corresponds to a management terminal or a management server of a management center that manages car navigation, or a car navigation apparatus mounted on another car.

Further, the communication system 1 may be a cellular phone communication system. In this case, for example, the terminals 10 correspond to cellular phones.

In addition, image data serving as sight data and sound data serving as hearing data are described as examples of content data in the above-described embodiments, the content data is not limited to these items of data, and the content data may be other five-sense data. For example, in the case where the content data is touch data, a feeling obtained by a user's contact at one terminal is transmitted to the other terminal side. Further, in the case where the content data is smell data, a smell at one terminal side is transmitted to the other terminal side. In addition, in the case where the content data is taste data, a taste at one terminal side is transmitted to the other terminal side.

Further, the content data may be at least one of image (sight) data, sound (hearing) data, touch data, smell data, and taste data.

In addition, although the case in which a videoconference is held by the communication system 1 has been described in the above-described embodiments, the embodiments are not limited to this case. The communication system 1 may be used in meetings, general conversation between family members or friends, or one-way presentation of information.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

1. A terminal management system comprising:
a first memory area that stores, for each one of a plurality of communication terminals, first terminal information indicating the communication terminal in association with terminal identification information for identifying the communication terminal;
a second memory area that stores, for each one of one or more of the plurality of communication terminals that is registered as a counterpart terminal for a request sender terminal capable of starting communication, second terminal information indicating the communication terminal in association with the terminal identification information for identifying the communication terminal, the second terminal information of the communication terminal being set by the request sender terminal; and
processing circuitry that updates, in response to updating of the first terminal information of a first communication terminal of the plurality of communication terminals, the second terminal information of the first communication terminal to match with the updated first terminal information.

2. The terminal management system of claim 1, wherein, when the request sender terminal includes a plurality of request sender terminals,
the processing circuitry updates the second terminal information of the first communication terminal, for each one of one or more of the plurality of request sender terminals having the first communication terminal registered for the request sender terminal.

3. The terminal management system of claim 1, further comprising:
a receiver that receives a request for changing the first terminal information of the first communication terminal, and
the processing circuitry updates the first terminal information of the first communication terminal in the first memory area in response to the request for changing.

4. The terminal management system of claim 3, further comprising:
a transmitter that transmits change information indicating updating of the first terminal information of the first communication terminal, to the request sender terminal that has the first communication terminal registered as a counterpart terminal in the second memory area.

5. The terminal management system of claim 1, wherein
the processing circuitry further receives permission for updating the second terminal information of the first communication terminal with the updated first terminal information from the request sender terminal that receives the change information, and
updates the second terminal information of the first communication terminal for the request sender terminal that sends the permission.

6. The terminal management system of claim 1, wherein
the second memory area further stores, for each one of the plurality of request sender terminals, permission/rejection information indicating whether to permit or reject updating of the second terminal information of the communication terminal registered for the request sender terminal, and
the processing circuitry updates the second terminal information of the first communication terminal, when the permission/rejection information of the request sender terminal having the first communication terminal registered as a counterpart terminal indicates that updating of the second terminal information of the communication terminal is allowed.

7. The terminal management system of claim 1, wherein
the second memory area further stores, for each one of the plurality of communication terminals that is registered as a counterpart terminal, permission/rejection information indicating whether to permit or reject updating of the second terminal information of the communication terminal, and
the processing circuitry updates the second terminal information of the first communication terminal when the permission/rejection information indicates that updating of the second terminal information of the first communication terminal is allowed.

8. The terminal management system of claim 1, wherein the first terminal information of the communication terminal includes a terminal name assigned to the communication terminal for common use, and the second terminal information of the communication terminal includes a terminal name assigned to the communication terminal for use by the request sender terminal that has the communication terminal registered as a counterpart terminal.

9. A communication system, comprising:
the terminal management system of claim 4; and
the request sender terminal connected to the terminal managements system through a network, the request sender terminal including:
a display that displays a screen based on the change information to a user, which includes at least the second terminal information of the first communication terminal and the updated first terminal information of the first communication terminal.

10. A method of managing terminal information, comprising:
storing, for each one of a plurality of communication terminals, first terminal information indicating the communication terminal in association with terminal identification information for identifying the communication terminal;
storing, for each one of one or more of the plurality of communication terminals that is registered as a counterpart terminal for a request sender terminal capable of starting communication, second terminal information indicating the communication terminal in association with the terminal identification information for identifying the communication terminal, the second terminal information of the communication terminal being set by the request sender terminal; and
updating, in response to updating of the first terminal information of a first communication terminal of the plurality of communication terminals, the second terminal information of the first communication terminal to match with the updated first terminal information.

11. The method of claim 10, wherein, when the request sender terminal includes a plurality of request sender terminals,
the updating includes updating the second terminal information of the first communication terminal, for each one of one or more of the plurality of request sender terminals having the first communication terminal registered for the request sender terminal.

12. The method of claim 10, further comprising:
receiving a request for changing the first terminal information of the first communication terminal; and
updating the first terminal information of the first communication terminal in response to the request for changing.

13. The method of claim 12, further comprising:
transmitting change information indicating updating of the first terminal information of the first communication terminal, to the request sender terminal that has the first communication terminal registered as a counterpart terminal.

14. The method of claim 10, further comprising:
receiving permission for updating the second terminal information of the first communication terminal with the updated first terminal information from the request sender terminal that receives the change information; and
updating the second terminal information of the first communication terminal for the request sender terminal that sends the permission.

15. The method of claim 10, further comprising:
storing, for each one of the plurality of request sender terminals, permission/rejection information indicating whether to permit or reject updating of the second terminal information of the communication terminal registered for the request sender terminal; and
updating the second terminal information of the first communication terminal, when the permission/rejection information of the request sender terminal having the first communication terminal registered as a counterpart terminal indicates that updating of the second terminal information of the communication terminal is allowed.

16. The method of claim 10, further comprising:
storing, for each one of the plurality of communication terminals that is registered as a counterpart terminal, permission/rejection information indicating whether to permit or reject updating of the second terminal information of the communication terminal; and
updating the second terminal information of the first communication terminal when the permission/rejection information indicates that updating of the second terminal information of the first communication terminal is allowed.

17. A non-transitory recording medium storing a plurality of instructions which, when executed by one or more processors, cause the processors to perform a method of managing terminal information comprising:
storing, for each one of a plurality of communication terminals, first terminal information indicating the communication terminal in association with terminal identification information for identifying the communication terminal;
storing, for each one of one or more of the plurality of communication terminals that is registered as a counterpart terminal for a request sender terminal capable of starting communication, second terminal information indicating the communication terminal in association with the terminal identification information for identifying the communication terminal, the second terminal information of the communication terminal being set by the request sender terminal; and
updating, in response to updating of the first terminal information of a first communication terminal of the plurality of communication terminals, the second terminal information of the first communication terminal to match with the updated first terminal information.
